(19) United States
(12) Patent Application Publication
(10) Pub. No.: US 2005/0165819 A1
(43) Pub. Date: Jul. 28, 2005

(54) Document tabulation method and apparatus and medium for storing computer program therefor

(76) Inventors: Yoshimitsu Kudoh, Tokyo (JP); Toshiko Aizono, Tokyo (JP); Atsuko Koizumi, Sagamihara (JP)

Correspondence Address: REED SMITH LLP, Suite 1400, 3110 Fairview Park Drive, Falls Church, VA, 22042, US

(21) Appl. No.: 10/932,026

(22) Filed: Sep. 2, 2004

(30) Foreign Application Priority Data
Jan. 14, 2004 (JP) 2004-006217

(51) Int. Cl. G06F 17/30

(52) U.S. Cl. 707/101

(57) ABSTRACT

Aids in creating axes from the bottom up using a huge volume of document data and, during the process, aids the user to discover an analytical point of view. The following processing is performed: (1) the system extracts search formula candidates for categories (referred to as category candidates) and the user selects from among the extracted category candidates; (2) the system creates axes from the category candidates selected by the user; and (3) the user determines a name of each axis (i.e., name of analytical point of view). Of these steps, the system aids in the step (1).

### INCORPORATION BY REFERENCE

The present application claims priority from Japanese application JP2004-006217 filed on Jan. 14, 2004, the content of which is hereby incorporated by reference into this application.

### BACKGROUND OF THE INVENTION

The present invention relates to text mining, information retrieving, cross tabulation and document classification.

Some methods have been proposed for preparing cross-tabulation tables from a huge volume of document data stored in a database and analyzing the tabulated document data. With the conventional methods, in a cross-tabulation table a plurality of items (called categories) and an arrangement of these items (called axis) are determined according to general knowledge such as date, sex and regional name and technical knowledge. The technical knowledge refers to background knowledge related to a content of document data. For example, a database in a call center for personal computers stores text-based inquiries from customers in the form of document data. To generate a cross-tabulation table from these document data requires technical knowledge associated with personal computers (component names and frequently encountered errors). Generating an axis of the cross-tabulation table is almost identical with determining a point of view in analysis, so the analytical point of view depends on general or technical knowledge. In a procedure for generating an axis according to the conventional method, first, a name of the axis is determined according to a point of view based on general or technical knowledge. Next, an arrangement of the categories making up the axis is determined. In a last step, search formulas corresponding to the individual category names are determined. More specifically, using technical knowledge about personal computers, the axis name is determined, e.g., “XXX series,” which is a series name of the personal computers, and then detailed category names of this “XXX series” are determined using type names (product names) of the personal computers belonging to that series, e.g., “77E7S,” “77F20T” and “77F7A.” Next, search formulas corresponding to the categories “77E7S,” “77F20T” and “77F7A” are named, such as “77E7S OR 77e7s,” “77F20T OR 77f20t” and “77F7A OR 77f7a” (OR is a logical operator). The axis of the cross-tabulation table is generated in a top-down manner, as described above. Examples of the conventional methods are cited as in JP-A-2001-273458, JP-A-2002-183175 and in IBM Japan, Tokyo Research Laboratory, “2D map—TAKMI—” [online], Dec. 10, 1999, Internet <URL: http://www.tr1.ibm.com/projects/s7710/tm/takmi/2dmap.htm>

With the conventional method of generating a cross-tabulation table in a top-down manner, the point of view of the cross-tabulation table generated from a large volume of document data stored in a database is biased by general knowledge or a predetermined technical point of view. It is difficult to discover previously undiscerned knowledge or more detailed knowledge from the cross-tabulation table having such a fixed point of view. In the case of a personal computer call center, for example, if there is an inquiry about an error phenomenon heretofore unknown in the technical knowledge, since the cross-tabulation table has no pertinent category, the associated data is hard to find. Thus, to discover previously undiscerned facts requires analyzing document data from a variety of points of view. In the conventional method the point of view is set mainly by an analyzer (i.e., the user of a text mining system). Here, a point of view that considers the content of document (simply referred to as a content-based point of view) will be discussed as one of important points of view other than those based on general and technical knowledge. For example, an error phenomenon of a personal computer failing to start can be analyzed in detail if a point of view is set according to the actual content of text-based inquiry, which may include various cases in which a screen is blackened, the screen freezes, or the computer fails to turn on at all.

In the above example, an axis corresponding to this point of view is given a name “error” and further settings are made, such as “start error” for a category and “fails to start OR cannot start” for a search formula. This setting of a point of view (axis), however, is accompanied by a work of grasping the whole content of a huge volume of document data and therefore is an extremely arduous process for the user. To alleviate such a burden on the user there is a method that generates an axis from the bottom up, an analogy of the aforementioned document clustering technique. With this method, however, the system automatically extracts characteristic words from the document and generates an axis with the characteristic words as categories. Therefore, the process of generating an axis does not reflect the analytical point of view of the user. That is, an axis not conforming to the analytical point of view of the user may be generated. For instance, in the case of the call center for personal computers, even if the user wishes to perform his or her analysis from a point of view of an error involved in software installed in “77E7S,” there is a chance of the system presenting the user with an axis showing a series of failures associated with components of “77E7S.” In such a case, the user finds it difficult to proceed with his analysis as he wants.

### SUMMARY OF THE INVENTION

In contrast to a conventional method that creates axes in a top-down manner from a technical or general point of view, this invention does not set a point of view beforehand but aids in creating axes from the bottom up using a huge volume of document data and, during the process, aids the user to discover an analytical point of view. Unlike the method that automatically creates axes from the bottom up, this invention considers an analytical point of view of the user in creating the axes.

This invention is built on a computer as a system. In this invention, in a process for the user to discover an analytical point of view, axes are created basically in an order reverse to that of the conventional method. The process includes the following steps: (1) the system extracts search formula candidates for categories (referred to simply as category candidates) and the user selects from among the extracted category candidates; (2) the system creates axes from the category candidates selected by the user; and (3) the user determines a name of each axis (i.e., name of analytical point of view). This invention aids in the step (1). That is, rather than the user manually checking all the category candidates extracted by the system and selecting appropriate ones, when the user selects an appropriate number of category candidates, the system learns semantic or conceptual characteristics of the category candidates and extracts and displays on the screen category candidates with similar characteristics. Thus the user can easily select appropriate category candidates from the displayed category candidates. Further, if, in the process of extracting the category candidates in step (1), the user can discover an analytical point of view, the axis creating process may be proceeded in a top-down manner as in the conventional method.

In a cross-tabulation table that uses categories extracted from a technical point of view, document data can only be analyzed from a fixed point of view. This invention, however, allows for analysis of document data from a variety of point of views reflecting the content of actual data well by creating cross-tabulation tables as described above.

Other objects, features and advantages of the invention will become apparent from the following description of the embodiments of the invention taken in conjunction with the accompanying drawings.

### BRIEF DESCRIPTION OF THE DRAWINGS

FIG. 1 illustrates an overall configuration of the system.

FIG. 2 shows a flow of an axis generation process.

FIG. 3 shows an axis generation support screen.

FIG. 4 shows an example co-occurrence words on the axis generation support screen.

FIG. 5 shows an example case of selecting co-occurrence words to add the same attribute to them on the axis generation support screen.

FIG. 6 shows an example case of narrowing down a document data set on the axis generation support screen.

FIG. 7 shows an example case of adding an attribute to terms on the attribute addition screen.

FIGS. 8A, 8B show example cases in which co-occurrence word vectors of attribute-added terms are chosen as category candidate extraction rules.

FIGS. 9A, 9B show example cases in which front and rear co-occurrence words of attribute-added terms in texts are set as category candidate extraction rules.

FIG. 10 shows example category candidates displayed on the axis generation support screen.

FIG. 11 shows an example case of setting an axis name on the axis generation screen 11000.

FIG. 12 shows an example case of selecting ordinate and abscissa of a cross-tabulation table on the cross-tabulation table generation screen.

FIG. 13 shows an example cross-tabulation table generated by a sampling system on the cross-tabulation table display screen.

FIG. 14 shows a data flow in the term extraction unit 4.

FIG. 15 shows a data flow in the axis generation support unit 3.

FIG. 16 shows a data flow in the cross tabulation unit 1.

FIG. 17 shows a data flow in the cross tabulation unit 11.

FIG. 18 shows an example synthesized axis on the synthesized axis display screen.

FIG. 19 shows an example case of displaying axis pairs for synthesized axes on the axis synthesis execution screen.

FIG. 20 shows an example case of displaying combinations of ordinate and abscissa for cross-tabulation tables on the cross-tabulation table selection display screen.

FIG. 21 shows a flow of an axis synthesizing process in the cross tabulation unit 11.

FIG. 22 shows an example cross-tabulation table generated by a conventional method on the cross-tabulation table display screen.

FIG. 23 shows an example cross-tabulation table generated by this system on the cross-tabulation table display screen.

FIG. 24 shows an example format in which unique expressions are stored in the extracted term storage unit 7.

FIG. 25 shows an example format in which modalities are stored in the extracted term storage unit 7.

FIG. 26 shows an example format in which co-occurrence words are stored in the extracted term storage unit 7.

FIG. 27 shows an example case of narrowing down a document data set on the axis generation support screen.

FIG. 28 shows a flow of processing to extract category candidates by using co-occurrence word vectors generated as category candidate extraction rules.

FIG. 29 shows a flow of processing to calculate a score of a synthesized axis.

FIG. 30 shows a configuration of the axis generation support screen with a synthesized axis generation function.

### DETAILED DESCRIPTION OF EMBODIMENTS

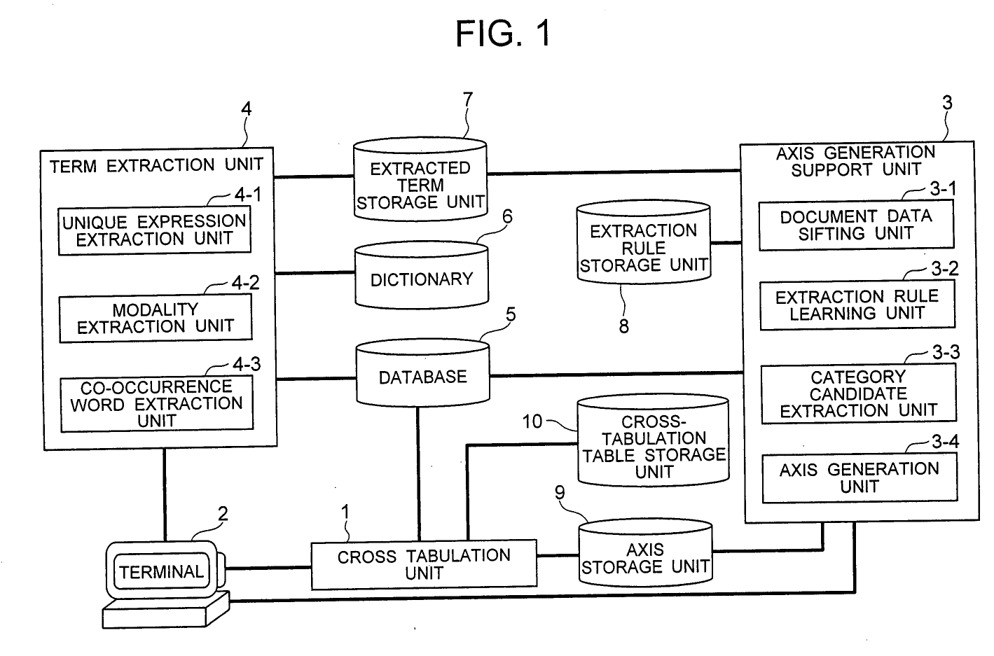

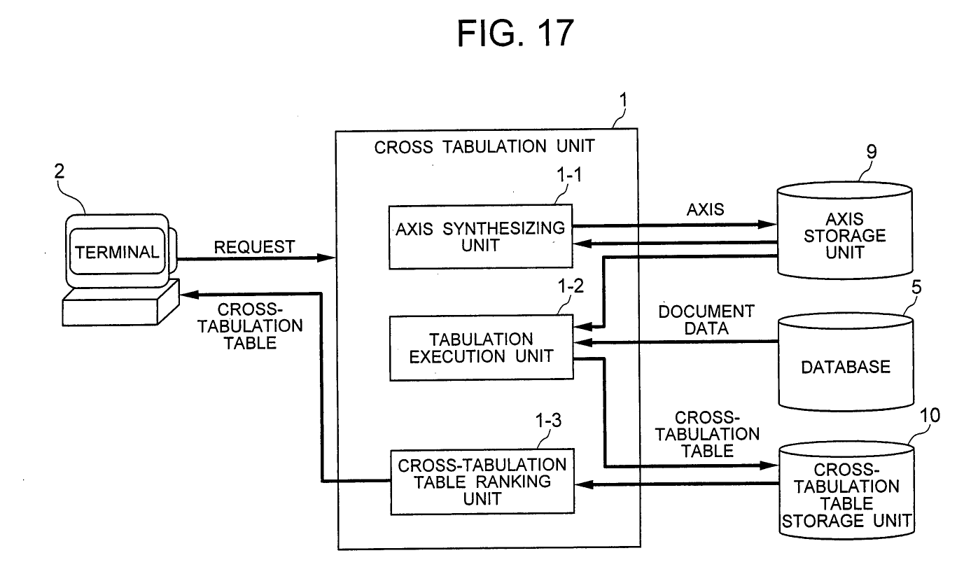

What is shown in FIG. 1 is a preferred embodiment of this invention. A cross tabulation unit 1 may have another configuration 11 shown in FIG. 17. One example embodiment of this invention will be described by referring to the accompanying drawings.

### 1. Description of Entire System

A configuration and a flow of processing in a text mining system as one embodiment of this invention will be explained.

1.1 Configuration

The configuration of the entire system is shown in FIG. 1. In this system one or more users use a terminal 2 to analyze a large volume of document data through cross tabulation. The cross tabulation is a tabulation method which generates a table (referred to as a cross-tabulation table) by using an axis made up of a plurality of categories as an ordinate and as an abscissa and sets in each cell of the table the number of search hits from the document data. The number put in one cell is a count of document data that hits an AND search as a search formula of the ordinate category and the abscissa category making up the cell.

This system extracts category candidates for axes to aid the generation of axes making up a cross-tabulation table. Words picked up as the category candidates are extracted from document data as by a linguistic element analysis. These words are referred to as terms in the description that follows.

This system comprises the following components:
a terminal 2 which receives instructions from the user for extracting terms from document data, for generating axes, or for performing cross tabulations on document data, and which provides the user with information necessary in the process of category candidate selection and axis generation;
a dictionary 6 used by a term extraction unit 4;
a term extraction unit 4 to extract, from a set of document data (referred to as a document data set) stored in a database 5, unique expressions by using a unique expression extraction unit 4-1, words representing modality (modality terms) by using a modality extraction unit 4-2, and co-occurrence words by using a co-occurrence word extraction unit 4-3;
an extracted term storage unit 7 to store terms extracted by the term extraction unit 4;
an axis generation support unit 3 consisting of a document data sifting unit 3-1 to sift through the document data set to narrow it down to a subset containing the terms specified by the user at the terminal 2; an extraction rule learning unit 3-2 to extract from the subset a plurality of terms co-occurring with the terms specified by the user (referred to as co-occurrence words), add the same attribute to those terms that can be category candidates and learn a pattern characteristic of the attribute-added terms (referred to as category candidate extraction rules); a category candidate extraction unit 3-3 to extract category candidates from the document data by using the category candidate extraction rules; and an axis generation unit 3-4 to generate one axis from the category candidates;
an extraction rule storage unit 8 to store category candidate extraction rules learned by the extraction rule learning unit 3-2;
an axis storage unit 9 to store axes generated by the axis generation unit 3-4;
a cross tabulation unit 1 to generate a cross-tabulation table using the axes stored in the axis storage unit 9 to cross-tabulate document data in the database 5; and
a cross-tabulation table storage unit 10 to store the cross-tabulation table generated by the cross tabulation unit 1.

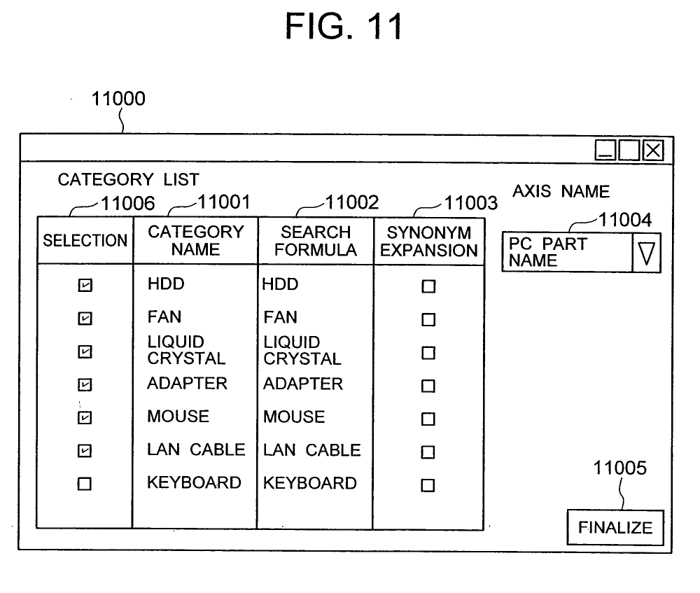

The terminal 2 is a general personal computer which has a processing unit, a memory unit, a user input device such as keyboard and mouse, a display unit and a communication unit to communicate with a server. The cross tabulation unit 1, the term extraction unit 4, the axis generation support unit 3 and a cross tabulation unit 11 of FIG. 11 (second embodiment of the cross tabulation unit 1) are programs that run on the computer. These programs are stored in media such as CD-ROM and hard disk and executed by the processing unit in the terminal 2 or in the server device that performs other functions. The database 5, the dictionary 6, the extracted term storage unit 7, the extraction rule storage unit 8, the axis storage unit 9 and the cross-tabulation table storage unit 10 are external storage devices. The external storage devices other than the dictionary 6 stores data generated by the system and sends and receives data to and from the processing unit that executes the programs. The dictionary 6 stores lexical information about entry words, parts of speech and inflected forms beforehand.

Here, an explanation will be given as to the unique expression and the modality. The unique expression refers to a term representing a proper noun, such as person's name, geographical name, organization's name (group name, corporation name) and product name, and a numerical expression such as date, time and price. For example, a company name, a product name and a date “Dec. 6, 2003” are among the unique expressions. The modality term is a term representing a mental attitude of a speaker toward an event. For example, “I want a repair” indicates a mental attitude that the speaker is “requesting” a repair; and “It will come out” indicates a mental attitude that the speaker “guesses” that it will come out. When the user attempts to single out category candidates by using a certain modality term as a reference, the user can find modality terms of the same kind as the one set by the user. For example, if the modality term used represents a “request,” similar modality terms representing a request, such as “want to improve” and “want to upgrade,” can be extracted using “want to” as a key.

Next, the co-occurrence word will be explained. The co-occurrence word is defined as terms that appear simultaneously in a certain range of document data. One example of range in which co-occurrence words can exist is a sentence. That is, if terms appear in the same sentence, these terms are treated as co-occurrence words.

1.2 Flow of Axis Generation

The flow of processing of this system can be divided into the following three phases:
Term extraction phase
Axis generation phase
Cross tabulation phase

1.2.1 Term Extraction Phase

In the term extraction phase, the term extraction unit 4 extracts from document data stored in the database 5 unique expressions, modality terms and those terms whose parts of speech are adjective and then stores them in the extracted term storage unit 7. This phase can be executed independently of other two phases. For example, when document data of the database 5 is updated, only the term extraction phase is executed. If the term used is predictable to some degree, a set of terms (product names, part names, etc.) prepared beforehand may also be used in combination.

1.2.2 Axis Generation Phase

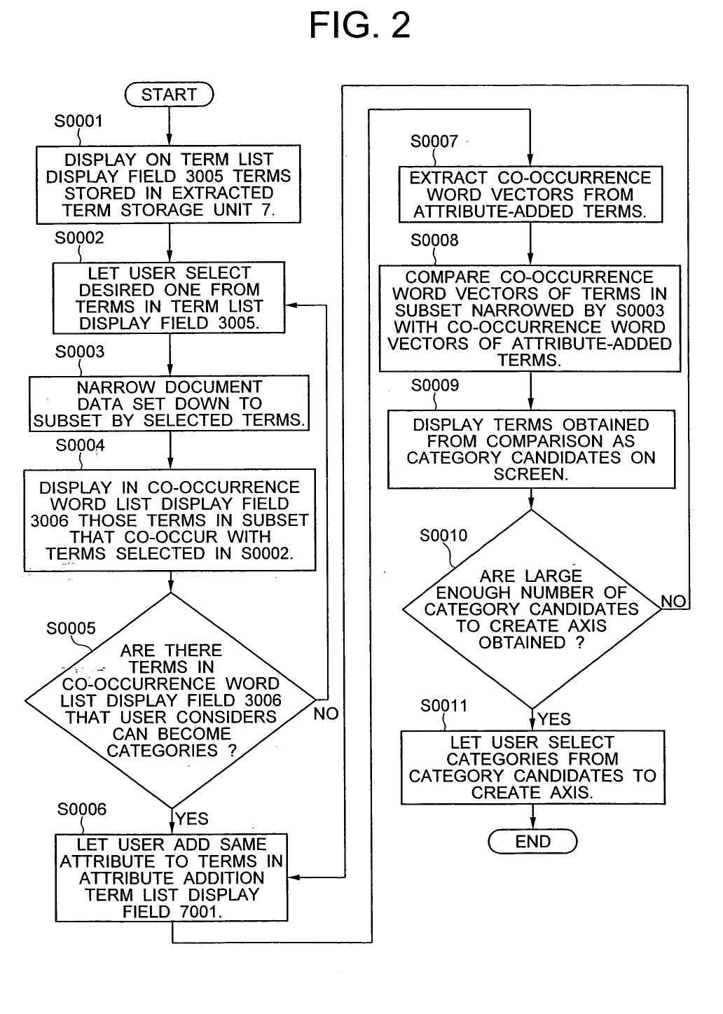

In the axis generation phase, the axis generation support unit 3 uses the terms stored in the extracted term storage unit 7 by the term extraction phase to aid the user in generating the axis. FIG. 2 shows the flow of processing. Correspondence between steps from S0001 to S0011 in the processing and relevant components in the axis generation support unit 3 is as follows.
S0001-S0005: Document data sifting unit 3-1
S0006-S0007: Extraction rule learning unit 3-2
S0008-S0010: Category candidate extraction unit 3-3
S0011: Axis generation unit 3-4

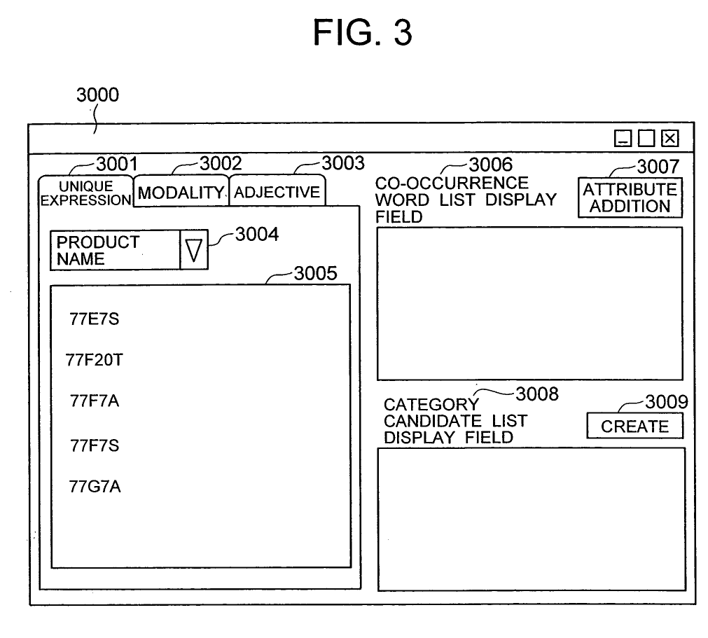

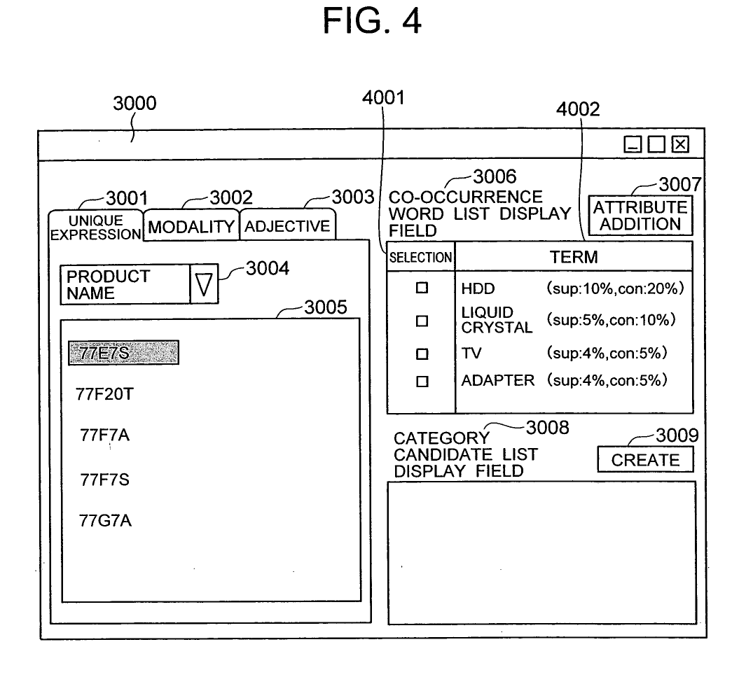

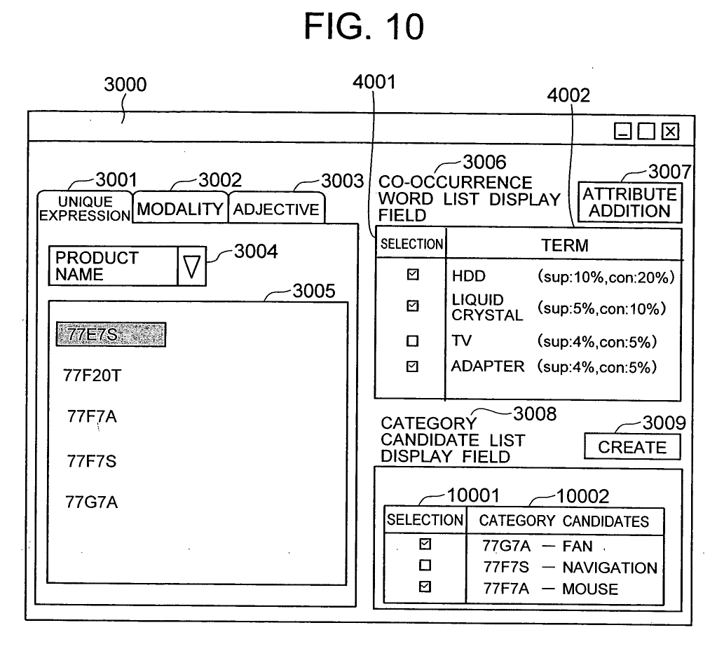

A configuration of the screen that the system displays on the terminal 2 during this phase will be explained for an example case of analyzing the customer query database in the personal computer call center. FIG. 3 shows an example screen configuration of this system. FIG. 3 represents an axis generation support screen 3000 which has tabs to choose the kind of term to be displayed on the screen, i.e., a unique expression tab 3001, a modality tab 3002, an adjective tab 3003, a co-occurrence word list display field 3006 to show co-occurrence words, an attribute addition button 3007 to display on the terminal 2 a screen for adding an attribute to the terms displayed in the co-occurrence word list 3006, a category candidate list display field 3008 to show category candidates, and an axis generation button 3009 to display on the terminal 2 a screen for generating the axis. The axis generation support screen 3000 also includes a kind selection field 3004 to select the kind of unique expression when the unique expression tab 3001 is selected and the kind of modality when the modality tab 3002 is chosen (this field is not shown on the screen when the adjective tab 3003 is chosen), and a term list display field 3005 to show the extracted unique expressions, modality terms or adjectives. While the co-occurrence words are displayed, the co-occurrence word list display field 3006, as shown in FIG. 4, has a co-occurrence word selection field 4001 in which to show check boxes for selecting the co-occurrence words and a co-occurrence word display field 4002 in which to show co-occurrence words. Further, as shown in FIG. 10, the category candidate list display field 3008 while category candidates are displayed has a category candidate selection field 10001 and a category candidate display field 10002.

When the user selects a term displayed in the term list display field 3005, its co-occurrence words appear in the co-occurrence word list display field 3006, as shown in FIG. 4. In the example of FIG. 4, a product name (type name) of a computer, “77E7S”, is selected in the term list display field 3005 and co-occurrence words such as “HDD” and “liquid crystal” are displayed in the co-occurrence word list display field 3006. Shown on the screen along with the co-occurrence words, values of “sup” represent levels of support and values of “con” represent levels of confidence. The support and the confidence are calculated by the document data sifting unit 3-1 when the term is retrieved from the extracted term storage unit 7. The 10% support for “HDD” means that document data containing “77E7S” and “HDD” is 10% of the entire document data. The 20% confidence for “HDD” means that 20% of the document data collection containing “77E7S” contains “HDD”. These two values indicate a co-occurrence strength between the terms. Based on these values, the co-occurrence word list display field 3006 shows the co-occurrence words of the selected term in the order of descending co-occurrence strength, thus alleviating the burden on the part of the user in referencing and selecting co-occurrence words. The standard of the co-occurrence strength is not limited to the support and confidence. Alternative means may include any means that measures the co-occurrence strength between terms, such as the number of document data containing two terms at the same time or a mutual information volume of these statistically processed document data.

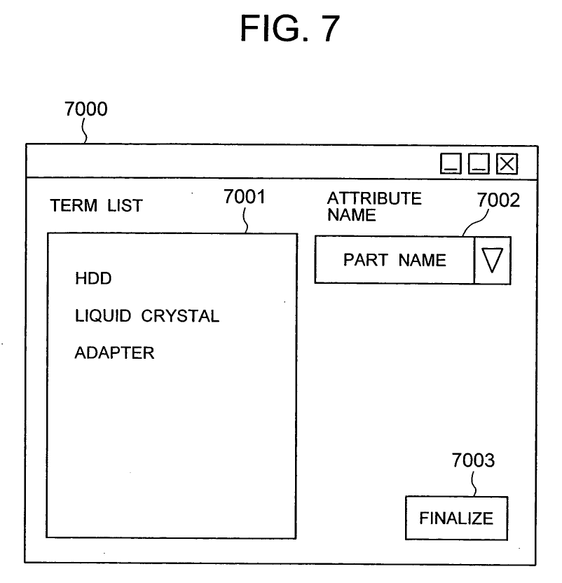

In step S0006 of adding the same attribute to a plurality of terms, an attribute addition screen 7000 of FIG. 7 is displayed on the terminal 2. The attribute addition screen 7000 has an attribute addition term list display field 7001 to show terms to which an attribute is to be added, an attribute name input field 7002 to input a new attribute name or select from existing attribute names, and an attribute addition decision button 7003.

In step S0011 of selecting category candidates, an axis generation screen 11000 of FIG. 11 appears on the terminal 2. The axis generation screen 11000 has a category name display field 11001 to show category names, a search formula display field 11002 to show a search formula used in an actual search through documents, a synonym expansion selection field 11003 to select a synonym expansion for the search formula, an axis name input field 11004 to enter a new axis name or select from existing axis names, an axis name decision button 11005, and a category name selection field 11006 having check boxes to select category names.

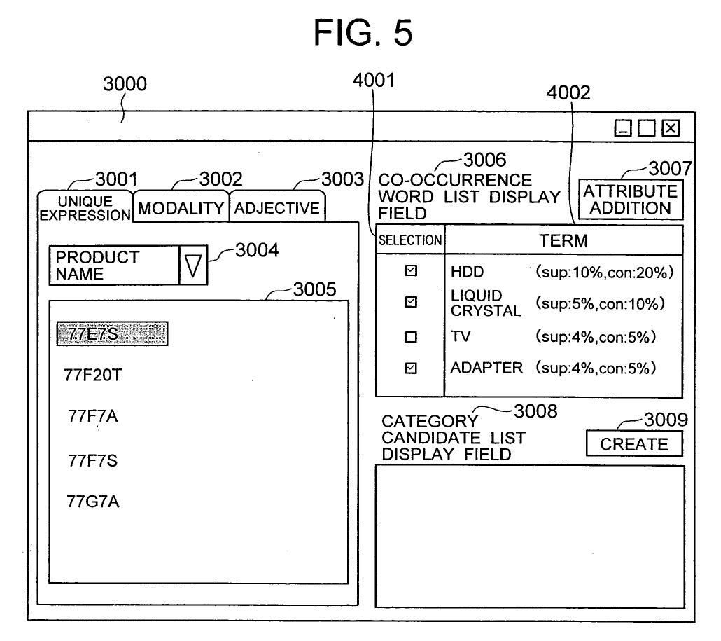

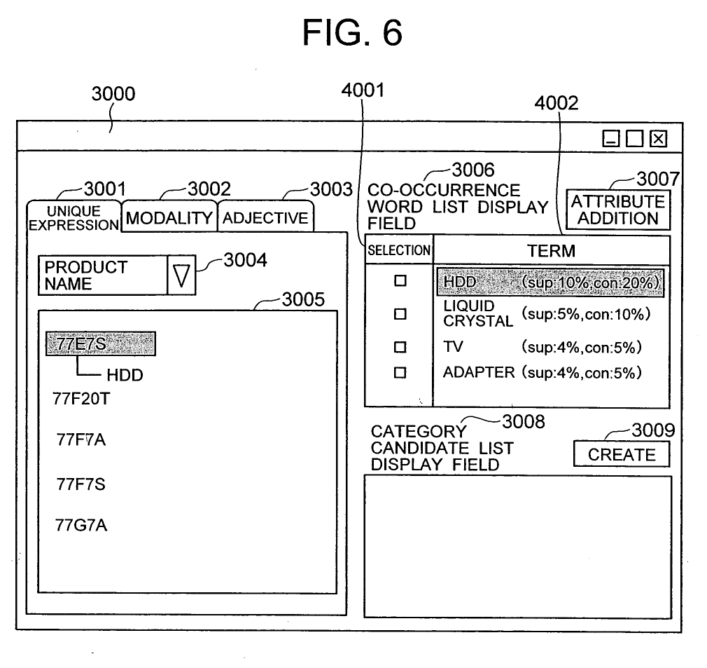

A processing flow from step S0001 to step S0011 on the screen of FIG. 3 to FIG. 5, FIG. 7, FIG. 10 and FIG. 11 is as follows.
S0001: Terms extracted beforehand from the document data stored in the call center database are displayed in the term list display field 3005. In the example of FIG. 3, the unique expression tab 3001 is selected, so the term list display field 3005 shows unique expressions extracted from the document data.
S0002-S0004: When the user selects a desired term from the term list display field 3005, the document data collection is sifted by the selected term to extract co-occurrence words and display them in the co-occurrence word list display field 3006. In the example of FIG. 4, the user has selected “77E7S” from the terms in the term list display field 3005 (S0002), so the system narrows the document data collection down to a document collection that includes “77E7S” (S0003) and displays the co-occurrence words in the co-occurrence word list display field 3006. In the example of FIG. 4, “HDD”, “liquid crystal”, “TV” and “adapter” are shown as co-occurrence words.
S0005: The user checks to see if there is a term in the co-occurrence word list display field 3006 which can be used as a category candidate. In the example of FIG. 5, the user decides that “HDD” is a category candidate and clicks on a check box in the co-occurrence word selection field 4001 to select “HDD.” Terms that seem conceptually relevant, “liquid crystal” and “adapter”, are also selected. Then, when the user clicks on the attribute addition button 3007, the system displays the attribute addition screen 7000 on the terminal 2 before proceeding to S0006. If the user decides that there is no category candidate, the system returns to step S0002. Again, the user chooses one term from the co-occurrence word list display field 3006 and performs sifting through the documents. In the example of FIG. 6, the user chooses “HDD” to further narrow the document data collection, which has been sifted by “77E7S”, down to a document collection that contains “HDD”. By extracting terms that co-occur with “HDD” from the document data collection that was sifted by “77E7S” and “HDD”, it is possible to discover in the sifted document data collection low-frequency terms which could not be found in the unsifted document data collection. To indicate the state of sifting, the term list display field 3005 of FIG. 6 shows “HDD” beneath “77E7S” in a hierarchical structure.
S0006: In the attribute addition screen 7000 of FIG. 7, the term selected by the user in step S0005 is shown in the attribute addition term list display field 7001. In the example of FIG. 5, since “HDD”, “liquid crystal” and “adapter” have been selected, these are displayed in the attribute addition term list display field 7001 of FIG. 7. The user then enters “part name” in the attribute name input field 7002 and clicks on the attribute addition decision button 7003 to determine the attribute.
S0007-S0009: From the documents containing the attribute

added terms, the category candidate extraction rules are learned. In the example of FIG. 7, “HDD”, “liquid crystal” and “adapter” are the attribute

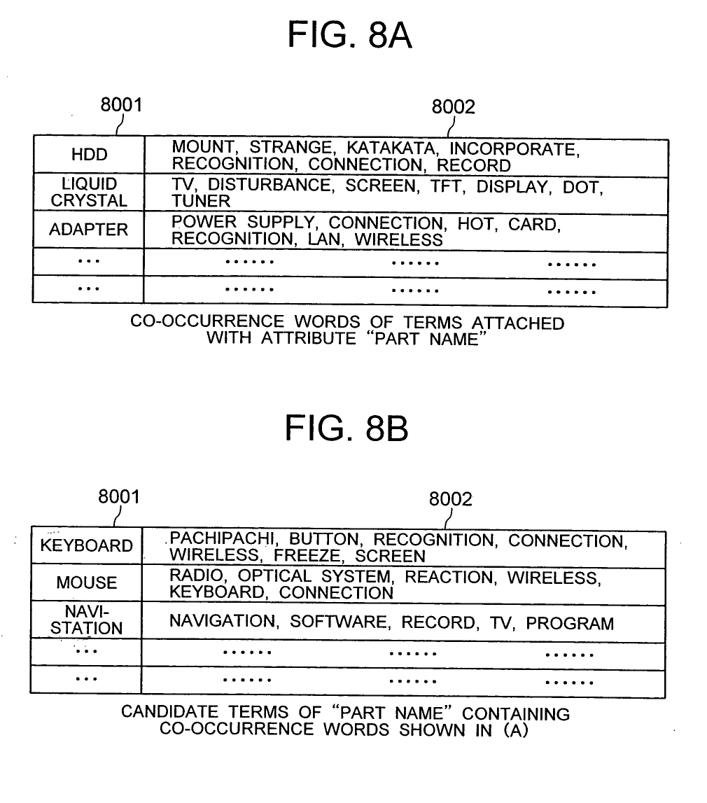

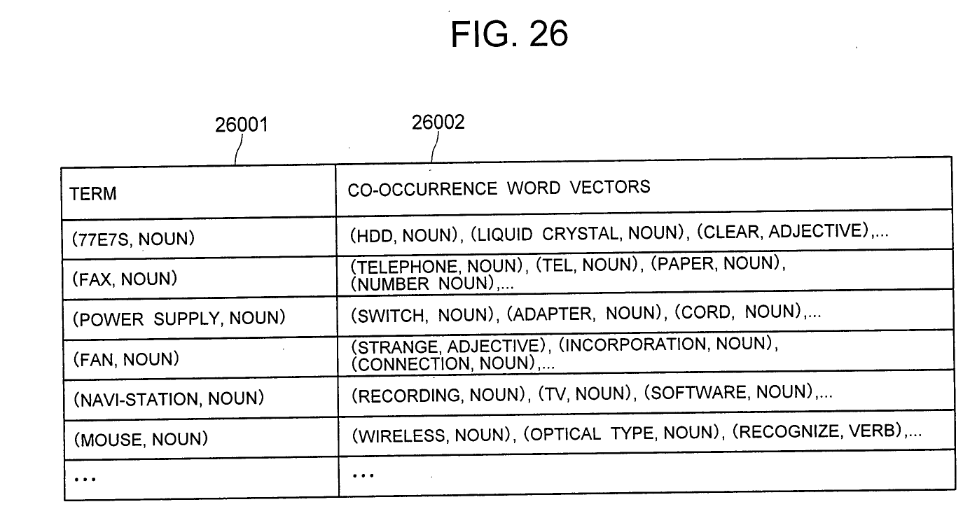

added terms, i.e., the terms to which the attribute “part name” is added. One of methods for learning rules is by extracting vectors of co-occurrence words of the attribute-added terms (referred to as co-occurrence word vectors). The co-occurrence word vectors are made up of high-frequency terms of those appearing in a document (or one sentence) which contains the attribute-added terms, and represent a tendency of terms that appear in the document containing the attribute-added terms. This is explained in the example case of FIG. 8. FIG. 8(a) shows attribute-added terms in an attribute-added term storage field 8001 and co-occurrence word vectors of these terms in a co-occurrence word vector storage field 8002. The co-occurrence word vectors of FIG. 8(a) are generated by the extraction rule learning unit 3-2. In practice, the co-occurrence word vectors are generated when the term extraction unit 4 extracts terms and then are stored beforehand in the extracted term storage unit 7. FIG. 26 shows a format in which the co-occurrence words are stored in the extracted term storage unit 7. The extraction rule learning unit 3-2 generates new co-occurrence word vectors by transforming the co-occurrence word vectors stored in the extracted term storage unit 7 into the format of co-occurrence word vectors of FIG. 8(a). A column 26001 stores combinations of terms and their parts of speech as co-occurrence word vectors and a column 26002 stores combinations of co-occurrence words of the associated term and their parts of speech as co-occurrence word vectors. That is, the co-occurrence word vectors of the attribute-added terms shown in FIG. 8(a) are copies of the co-occurrence word vectors of FIG. 26 minus their parts of speech information.

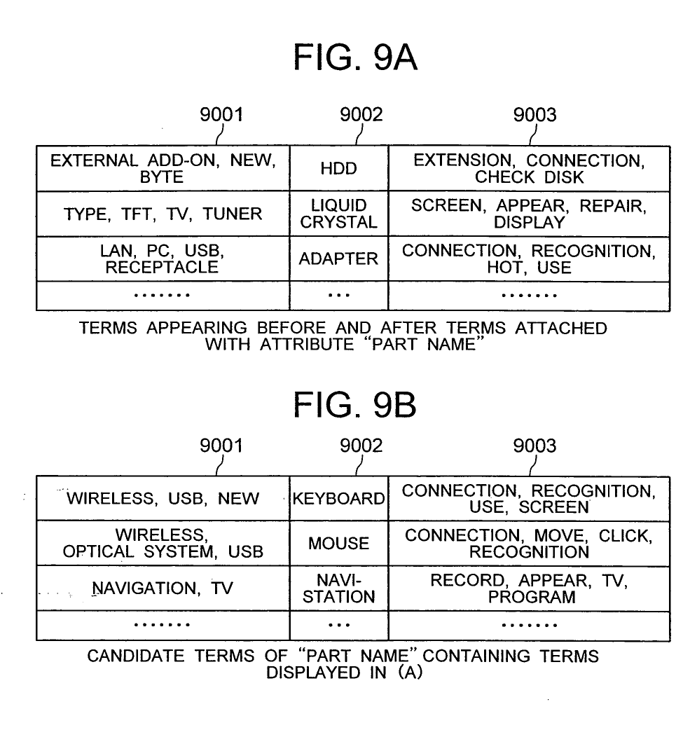

Further, the combinations of the attribute-added terms and the co-occurrence word vectors are stored as the category candidate extraction rules in the extraction rule storage unit 8. The co-occurrence words of “HDD” are “recognize” and “connection” for example. Those terms which include, as the co-occurrence words in the co-occurrence word vectors, the same terms as the co-occurrence words contained in the co-occurrence word vectors of the attribute-added terms are extracted by the extraction rule learning unit 3-2 from the extracted term storage unit 7 as the candidates for the terms having the attribute “part name”. In the example of FIG. 8, terms “keyboard”, “mouse” and “navi-station”, which include in the co-occurrence word vectors such co-occurrence words as “recognize”, “connection” and “record” for the attribute-added terms “HDD”, “liquid crystal” and “adapter”, are extracted from the extracted term storage unit 7 as candidates for the terms having an attribute “part name” and are then stored in the extraction rule storage unit 8 minus their parts of speech (FIG. 8(b)). Processing performed by the extraction rule learning unit 3-2 will be explained in detail later. The extracted terms are shown in the category candidate list display field 3008 as shown in FIG. 10. Another method of obtaining the category candidate extraction rules may be as follows. In a text containing an attribute-added term, the method extracts terms frequently appearing near the head of the text before the attribute-added term (referred to as front co-occurrence words) and terms frequently appearing near the end of the text (referred to as rear co-occurrence words), and stores the front co-occurrence word vectors, the attribute-added term and the rear co-occurrence word vectors as the category candidate extraction rules in the extraction rule storage unit 8. This method can basically be considered to be the co-occurrence word vectors of FIG. 8 to which a front-rear positional relation restriction is applied. If the format of FIG. 9(a) is adopted as the category candidate extraction rules, information on the term appearing position is added to the co-occurrence word vectors to be stored in the extracted term storage unit 7. That is, information on the location of appearance, which indicates whether the term in question appears before or after the term of the column 26001, is added to the two

part combinations of the terms making up the co-occurrence word vectors and their parts of speech, such as shown in FIG. 26. This transforms the two

part combination into a three-part combination.

Using the extracted term storage unit 7, which stores the co-occurrence word vectors in the above format, the extraction rule learning unit 3-2 generates co-occurrence word vectors in a format conforming to that of the co-occurrence word vectors of the attribute-added terms, as shown in FIG. 9(a). The example of FIG. 9 will be briefly explained. The front co-occurrence word vectors that appear in a text before the attribute-added term are stored in a front co-occurrence word vector storage field 9001; the attribute-added terms are stored in an attribute added term storage field 9002; and the rear co-occurrence word vectors that appear in the text after the attribute-added term are stored in a rear co-occurrence word vector storage field 9003. The front co-occurrence words of “HDD” include “external add-on” and “new” and the rear co-occurrence words include “extension” and “connection.” Terms having the same front and rear co-occurrence words as these front and rear co-occurrence words are picked up as candidates for part names. That is, “keyboard”, “mouse” and “navi-station”, which have in their co-occurrence word vectors the same front and rear co-occurrence words as those of the terms “HDD”, “liquid crystal” and “adapter” (e.g., “new”, “TV” and “USB” as the front co-occurrence words and “connection”, “screen” and “appear” as rear co-occurrence words), are extracted as candidates for the terms having an attribute “part name” (FIG. 9(b)). The extracted terms, as in the case of FIG. 8, are displayed in the category candidate list display field 3008 of FIG. 10. The user now decides that “keyboard” and “mouse” displayed in the category candidate list display field 3008 of FIG. 10 are parts of the personal computer, selects check boxes in the category candidate selection field 10001 and clicks on the attribute addition button 3007 to display the attribute addition screen 7000 on the terminal 2, in which the user similarly adds the attribute “part name”.
S0010-S0011: Once enough category candidates to form an axis are obtained, the axis is generated. In the axis generation screen 11000, category names such as “HDD”, “fan” and “liquid crystal” are displayed in the category name display field 11001. The user may edit a search formula in the search formula display field 11002. For example, the user may edit the search formula “HDD” into “HDD OR hard disk”. Further, the user clicks on desired check boxes in the category name selection field 11006 to give a name to one axis made up of the selected categories. In the example of FIG. 11, “PC part” is entered into the axis name input field 11004. If a sufficient number of category candidates cannot be obtained, the system returns to step S0006 and starts the attribute addition sequence again.

As for the selection of term in step S0002, although in the case of FIG. 4 the user selects a single term, a plurality of terms can be chosen. In that case, for each of the selected terms, co-occurrence words are obtained and they are displayed en masse in the co-occurrence word list display field 3006. Thus, the number of co-occurrence words displayed becomes large, making it difficult for the user to check all the co-occurrence words to see if they are conceptually or semantically related. To get around this problem, when the number of co-occurrence words displayed in the co-occurrence word list display field 3006 is large, the user can pick up an appropriate number of terms from the co-occurrence words, add an attribute to them to generate attribute-added terms, and perform steps S0007-S0009 on these terms. As a result, terms that are considered to be able to be given the same attribute are displayed as the category candidates in the category candidate list display field 3008. The user selects terms displayed in the category candidate list display field 3008 and adds the same attribute to the selected terms, thus completing the attribute addition process easily. Therefore, the user does not have to check all the co-occurrence words displayed in the co-occurrence word list display field 3006.

In conventional methods, finding category candidates from document data has been an arduous process. With this method, however, the axis generation phase, which automatically discovers category candidates, can alleviate the burden on the user.

1.2.3 Cross Tabulation Phase (In the Case of Cross Tabulation Unit 1)

In the cross tabulation phase, the user in a cross

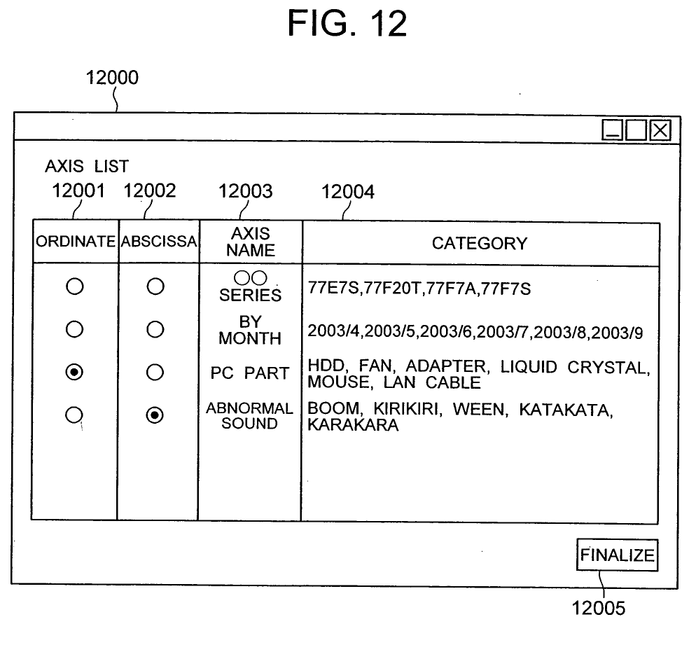

tabulation table generation screen 12000 of FIG. 12 selects an ordinate and abscissa for the cross-tabulation table and the cross tabulation unit 1 executes the cross tabulation to generate a cross-tabulation table. The cross

tabulation table generation screen 12000 has an ordinate selection field 12001 made up of radio buttons for ordinate selection, an abscissa selection field 12002 made up of radio buttons for abscissa selection, an axis name display field 12003, a constitutional category display field 12004 for displaying categories making up the axis, and a cross tabulation decision button 12005. In the example of FIG. 12, axis names, such as “XXX series”, “by month”, “PC part” and “abnormal sound”, are shown in the axis name display field 12003 and categories making up the axis, such as “77E7S”, are shown in the constitutional category display field 12004. An axis “XXX series” may also be generated beforehand by using information contained in product catalogs. Another axis “by month” can also be generated beforehand by referring to the date on which the document data was registered with the database. Axis “PC part” and axis “abnormal sound” are axes discovered from the document data in the axis generation phase.

On the cross

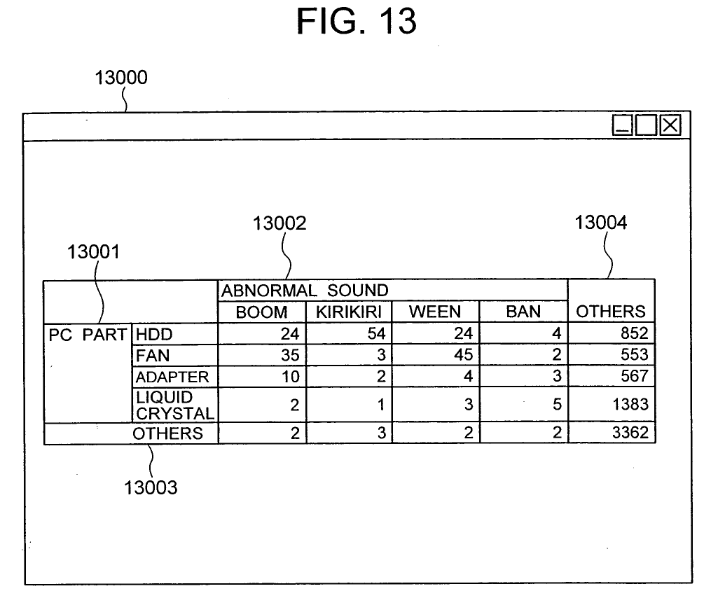

tabulation table generation screen 12000 on the terminal 2, the user selects an ordinate and an abscissa of the cross-tabulation table by clicking on a radio button in the ordinate selection field 12001 and a radio button in the abscissa selection field 12002. In the example of FIG. 12, “PC part” is selected as the ordinate and “abnormal sound” as abscissa. Then, clicking on the cross tabulation decision button 12005 causes the cross tabulation unit 1 to generate a cross-tabulation table. The generated cross-tabulation table is shown on a cross-tabulation table display screen 13000 of FIG. 13. The cross-tabulation table display screen 13000 has an ordinate display field 13001 for displaying ordinate categories, an abscissa display field 13002 for displaying abscissa categories, and an ordinate “others” category 13003 and an abscissa “others” category 13004 for displaying the number of document data not tabulated in the cells of the cross-tabulation table.

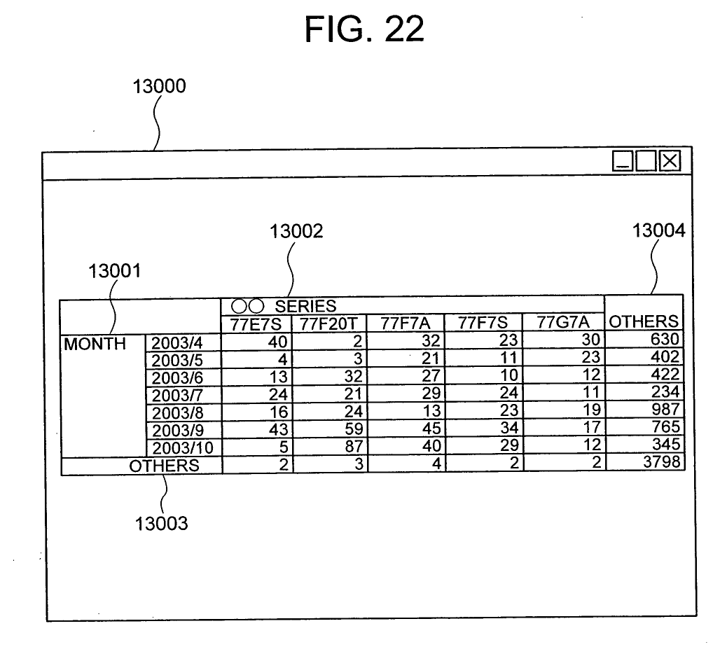

In the example of the cross-tabulation table shown in FIG. 13, the relation between PC parts and abnormal sounds can be discovered in “customers' voice” collected as text data in the call center and it is then understood that “the computer users communicate failures of their PC parts to the call center by means of abnormal sounds”. As a result, it is possible to make an analysis of failures of PC parts from the point of view of abnormal sound. The system of this invention therefore can easily generate a cross-tabulation table as seen from a content-based point of view (in this example, a customers' voice viewpoint of failure and abnormal sound). In the conventional method, however, the predetermined axes “XXX series” and “by month” are used to generate a cross-tabulation table of FIG. 22 that depends on technical or general point of view. From such a cross-tabulation table it is difficult to discover a knowledge hidden in the document data that “computer users often express failures with sound.” This invention therefore can solve the problems encountered with the conventional method.

1.2.4 Cross Tabulation Phase (In the Case of Cross Tabulation Unit 1)

Another embodiment of the cross tabulation unit 1 is a cross tabulation unit 1 shown in FIG. 17. The cross tabulation unit 1 comprises an axis synthesizing unit 1-1, a tabulation execution unit 1-2 and a cross-tabulation table ranking unit 1-3.

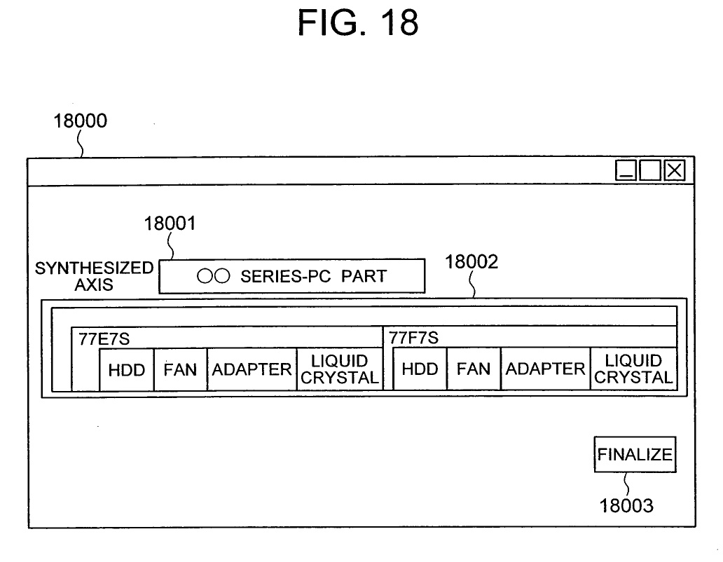

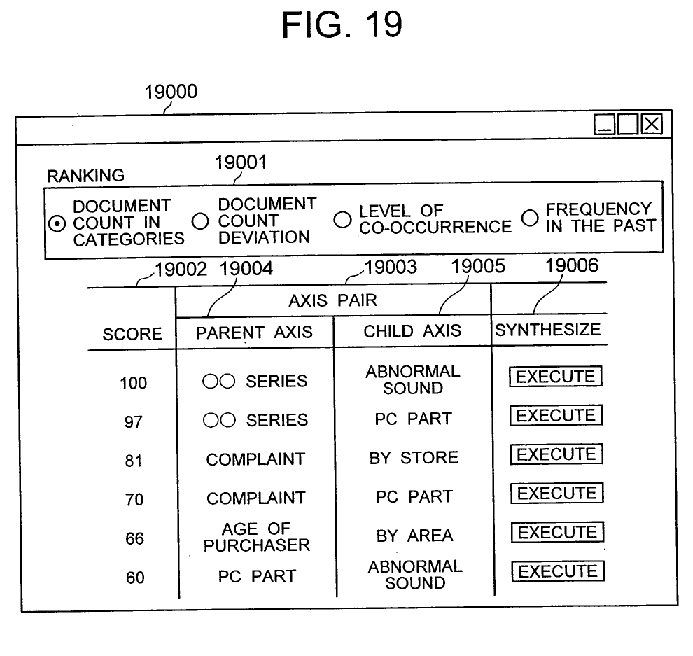

In the cross tabulation phase using the cross tabulation unit 1, the user first synthesizes the axes in an axis synthesis execution screen 19000 of FIG. 19. The axis synthesizing involves selecting two axes from the axis storage unit 9 and generating a new axis that has a search formula formed by combining a search formula for one of the two axes and a search formula for the other through an AND operator. The axis synthesis execution screen 19000 of FIG. 19 has a ranking reference selection field 19001 to select a reference (or score to evaluate a synthesized axis) used in determining an order of display on the screen of a pair of axes (raw axis pair) stored in the axis storage unit 9 (referred to as raw axes for distinction from the synthesized axis (described later)); a score display field 19002 to display a synthesized score for the two axes; a raw axis pair display field 19003 to display raw axis pairs; a parent axis display field 19004 to display parent axis candidates for raw axis pairs; a child axis display field 19005 to display child axis candidates; and a synthesis execution field 19006 having buttons to execute the synthesizing operation. Unless otherwise specifically noted, the word axis refers to a raw axis. The user synthesizes raw axes by referring to the values shown in the score display field 19002. The reference shown in the ranking reference selection field 19001 will be described later. An axis obtained by the synthesizing operation is called a synthesized axis. FIG. 18 shows a synthesized axis display screen 18000 which has a synthesized axis name input field 18001 in which to enter a name of a synthesized axis, a synthesized axis display field 18002 to display a synthesized axis, and a synthesized axis decision button 18003 to finalize the displayed synthesized axis. As shown in the synthesized axis display field 18002 of FIG. 18, the synthesized axis consists of a higher-level axis (referred to as a parent axis) and a lower-level axis (a child axis). In the example of FIG. 18, the parent axis of the synthesized axis in the synthesized axis display field 18002 is “XXX series” having such categories as “77E7S” and “77F7S” and the child axis is “PC part” having such categories as “HDD” and “fan”.

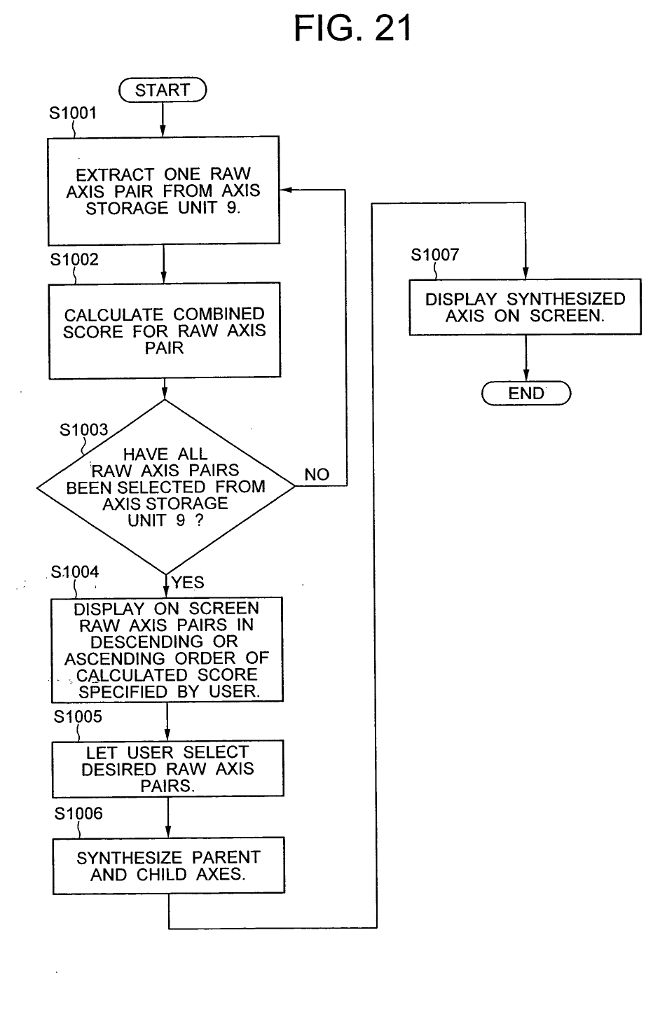

The axis synthesizing is executed by the axis synthesizing unit 1-1. The axis synthesizing unit 1-1 generates synthesized axes from all combinations of raw axes stored in the axis storage unit 9. FIG. 21 shows a flow of axis synthesizing processing. The following explanation takes the screen of FIG. 19 as an example.
S1001-S1004: Two axes are extracted as a raw axis pair from such axes as “XXX series”, “PC part” and “abnormal sound” in the axis storage unit 9; and four scores for the raw axis pair, i.e., “document count in categories”, “document count deviation”, “level of co-occurrence” and “frequency in the past”, are calculated. In the example of FIG. 19, according to one score “the number of texts for the category”, the raw axis pairs are arranged in a desired order, e.g., “XXX series” and “abnormal sound”, or “XXX series” and “PC part”, and displayed on the screen.
S1005-S1006: From the raw axis pairs shown on the screen, the user selects a desired one and executes the synthesizing of the selected raw axes. In the example of FIG. 19, when the user clicks on the synthesis execution button for the raw axis pair of “XXX series”- “PC part”, the axis synthesizing unit 1-1 generates a synthesized axis.
S1007: The synthesized axis is displayed in the synthesized axis display field 18002 of FIG. 18.

The tabulation execution unit 1-2 makes all possible combinations of the axes stored in the axis storage unit 9 to generate a plurality of cross-tabulation tables and stores the generated cross-tabulation tables in the cross-tabulation table storage unit 10.

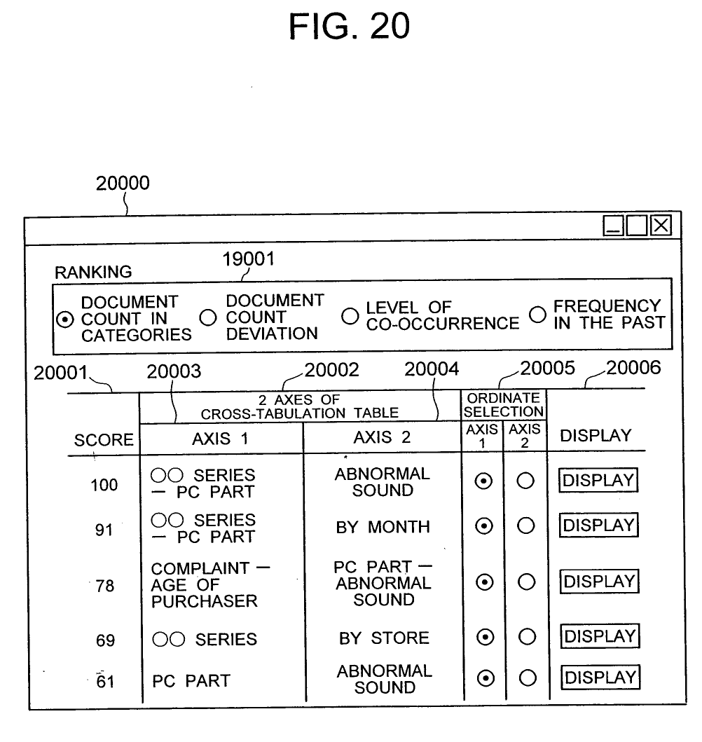

The cross-tabulation table ranking unit 1-3 calculates scores for the cross-tabulation tables stored in the cross-tabulation table storage unit 10. The scores are the same that are used in the axis synthesizing unit 1-1. The cross-tabulation tables are arranged in a descending order of scores in a cross-tabulation table selection display screen 20000 of FIG. 20. The cross-tabulation table selection display screen 20000 has a ranking reference selection field 19001 similar to that of FIG. 19, a score display field 20001 to display values that constitute references used in evaluating the cross-tabulation tables, a two

axis display field 20002 to display the two axes of each cross-tabulation table, an axis-1 display field 20003 for one of the two axes and an axis-2 display field 20004 for the other, an ordinate selection field 20005 to select an ordinate of each cross-tabulation table, and a display execution field 20006 having buttons to execute the display of the cross-tabulation tables. The user selects a cross-tabulation table he or she wants displayed on the screen by referring to the scores shown in the score display field 20001. By selecting a desired cross-tabulation table according to the score as described above, the user can make an objective comparison among multiple cross-tabulation tables.

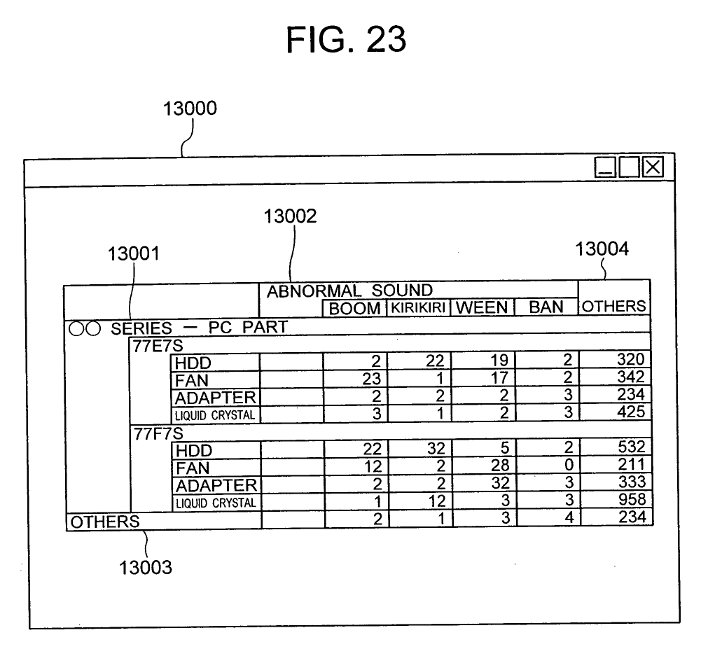

For example, if a cross-tabulation table with an axis-1 of “XXX series-PC part” and an axis-2 of “abnormal sound” is displayed with the axis-1 as the ordinate, a cross-tabulation table shown in FIG. 23 appears on the screen. Compared with a cross-tabulation table of the conventional method shown in FIG. 22, the cross-tabulation table of FIG. 23 has its axis related to the product name (ordinate) detailed down to PC part by the synthesized axis as shown. Further, this table has an axis (abscissa) of abnormal sound, obtained from the content-based point of view. It is therefore possible to generate a cross-tabulation table based on the content of document data.

The parent axis and child axis of a synthesized axis and the ordinate and abscissa of a cross-tabulation table are determined by a certain score. The detail of this method will be described later.

### 2. Description of Constitutional Component

2.1 Term Extraction Unit

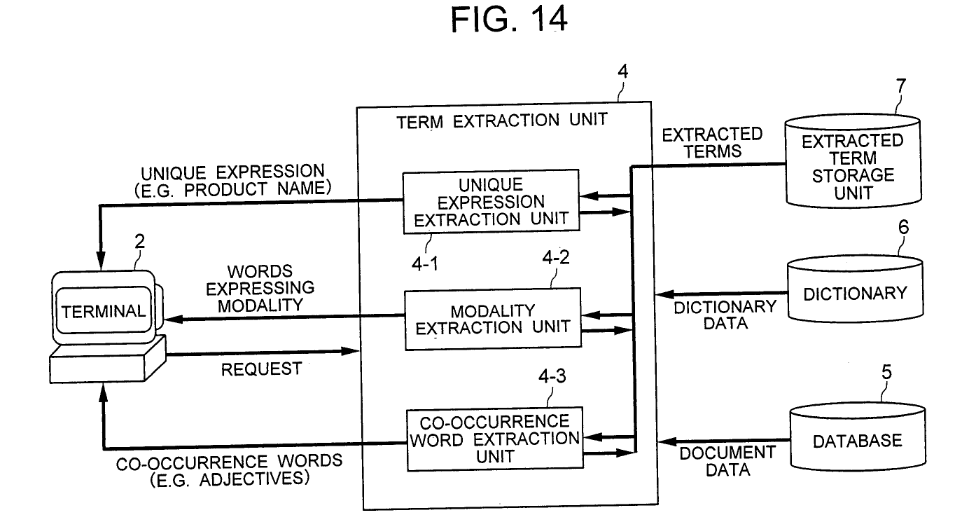

The term extraction unit 4 comprises a unique expression extraction unit 4-1, a modality extraction unit 4-2 and a co-occurrence word extraction unit 4-3. It can also be constructed of any combination of these. FIG. 14 shows a detail of the term extraction unit 4 including a flow of data.

2.1.1 Function

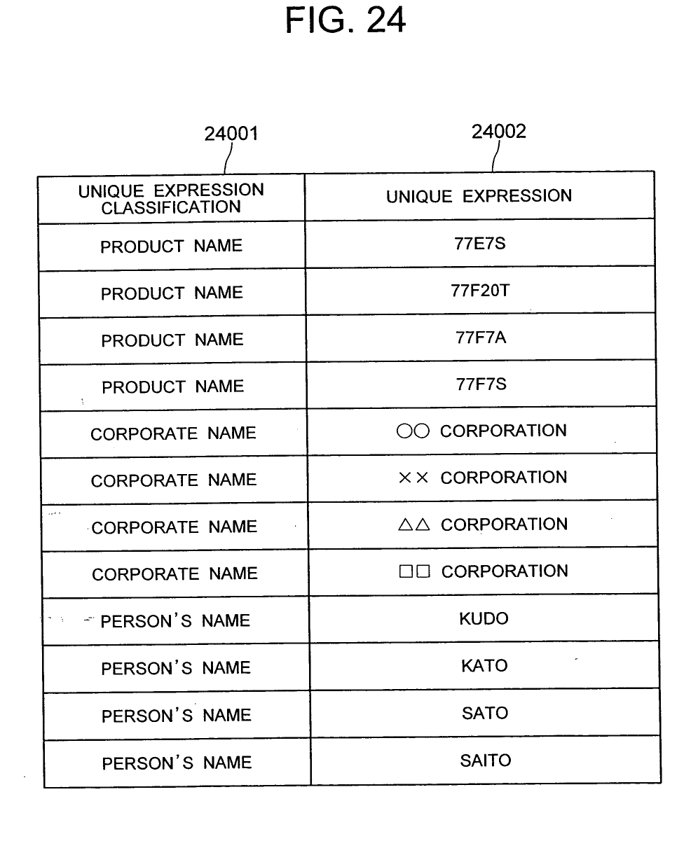

The unique expression extraction unit 4-1 extracts unique expressions, such as person's name, organization name, product name, date and time, and price, by using a unique expression extraction method such as explained in a literature “Information Extraction from Texts—Extracting particular information from documents—” (Satoshi Sekine, Johoshori Gakkai Journal, Vol. 40, No. 4, 1990). The organization names and product names that are already known may be registered beforehand with the dictionary 6 to improve the search efficiency. For example, an organization name, such as “XXX corporation”, and a product name can be gathered from corporate information sites and product catalogues, and therefore these information can easily be registered with the dictionary 6. The unique expression extraction unit 4-1 can extract new unique expressions not found in the dictionary by referring to the dictionary 6 and learning the unique expression extraction rules. Further, the unique expression extraction unit 4-1 stores the extracted unique expressions in the extracted term storage unit 7. FIG. 24 shows examples of unique expressions stored in the extracted term storage unit 7. A unique expression classification storage field 24001 stores kinds of unique expressions, such as “product name”, “company name” and “person's name”, and a unique expression storage field 24002 stores values of unique expressions, such as “77E7S” and “XXX corporation”.

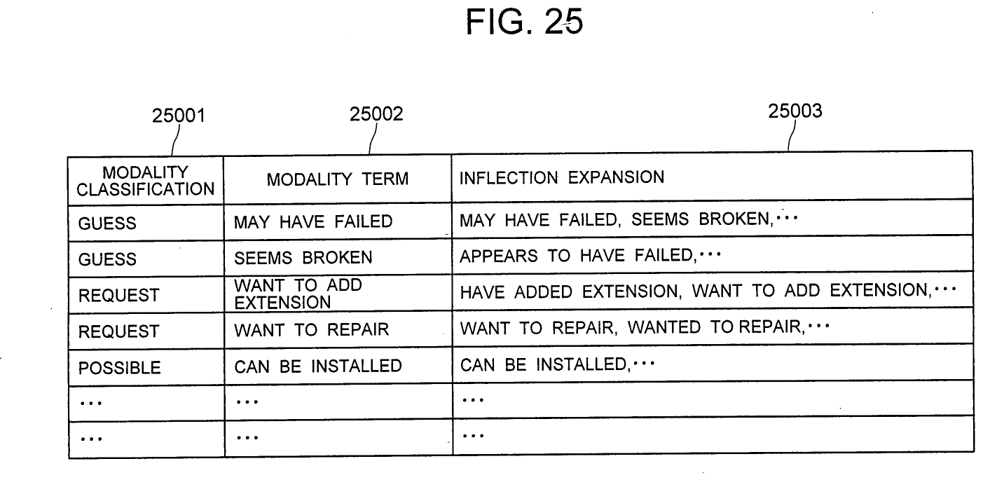

The modality extraction unit 4-2 extracts modality terms expressing “wishes”, “guesses”, etc. In the case of “wishes”, the extraction is made by using “like to”, “want to”, etc. as keys. In the case of “guesses”, the extraction is done by taking “may be”, “appear to be”, etc. as keys for extraction. Then, the extracted modality terms are stored in the extracted term storage unit 7. FIG. 25 shows examples of modality terms. A modality term storage area in the extracted term storage unit 7 consists of a modality classification field 25001, a modality term field 25002 and an inflection expansion field 25003. For example, “want to extend” and “want to repair” are extracted as modality terms expressing the details of “wishes”. “May have been broken” and “may have failed” are extracted as modality terms expressing the details of “guesses”.

The co-occurrence word extraction unit 473 extracts terms the co-occur with a certain term in the document data. One of such existing methods is found in JP-A-2002-183175. This invention adopts this method. Suppose, for example, “HDD”, “katakata” (rattling noise) and “external add-on” often appear together in one and the same document data. Then, “katakata” and “external add-on” are extracted as co-occurrence words of “HDD”. Further, the co-occurrence word extraction unit 4-3 stores the extracted co-occurrence words in the extracted term storage unit 7. For instance, the terms and their co-occurrence words are linked together when they are stored, as shown in the table of FIG. 26.

2.1.2 Flow of Data

Referring to FIG. 14, data flows for the unique expression extraction unit 4-1, the modality extraction unit 4-2 and the co-occurrence word extraction unit 4-3 will be explained.

The unique expression extraction unit 4-1 extracts from document data stored in the database 5 terms indicating unique expressions (persons' names, organization names, product names, dates and times, prices, etc.) by using data of the dictionary 6, i.e., registered organization names and product names, and then stores the extracted terms in the extracted term storage unit 7. When the user clicks on the unique expression tab 3001 in the axis generation support screen 3000 on the terminal 2, a unique expression referencing request is sent to the unique expression extraction unit 4-1. Then, the unique expression extraction unit 4-1 displays the terms stored in the extracted term storage unit 7 on the terminal 2. For example, in the axis generation support screen 3000 of FIG. 3, the user can select unique expressions as terms to be displayed on the term list display field 3005 by clicking on the unique expression tab 3001. Selecting “product name” in the kind selection field 3004 causes the terminal 2 to issue a request for referencing product names. In response to this request, the unique expression extraction unit 4-1 displays in the term list display field 3005 product names, such as “77E7S”, “77F20T” and “77F7A”, from the extracted term storage unit 7.

The modality extraction unit 4-2 extracts from the document data stored in the database 5 modality terms representing “wishes” and “guesses”. In the case of “wishes”, the unit extracts modality terms expressing wishes, such as “want to improve” and “want to upgrade”, by using “want to” as a key. The modality extraction unit 4-2 also processes requests from the user sent from the terminal 2, e.g., a request for displaying modality terms indicating “wishes”, and displays in the term list display field 3005 of FIG. 3 modality terms stored in the extracted term storage unit 7, such as “want to repair” and “fail to connect”. At this time, to display, modality terms, the user clicks on the modality tab 3002 of FIG. 3 to select the display of modality terms.

The co-occurrence word extraction unit 4-3 extracts from the document data stored in the database 5 terms that appear simultaneously in the same document as co-occurrence words, links the extracted terms with their parts of speech and stores them in the extracted term storage unit 7. The co-occurrence word extraction unit 4-3 also processes user requests sent from the terminal 2 and displays in the term list display field 3005 of FIG. 3 only adjectives from among the co-occurrence words stored in the extracted term storage unit 7. That is, the units refers to the parts of speech information on the terms extracted as the co-occurrence words, singles out only those terms whose parts of speech are adjective and displays the extracted terms in the term list display field 3005. If, for example, adjectives such as “pretty” and “stylish” are among the co-occurrence words of the product name “77E7S”, these adjectives are displayed in the term list display field 3005. At this time, to display the adjectives, the user clicks on the adjective tab 3003 for their display. When the adjective tab 3003 is selected, the kind selection field 3004 is hidden.

2.2 Axis Generation Support Unit

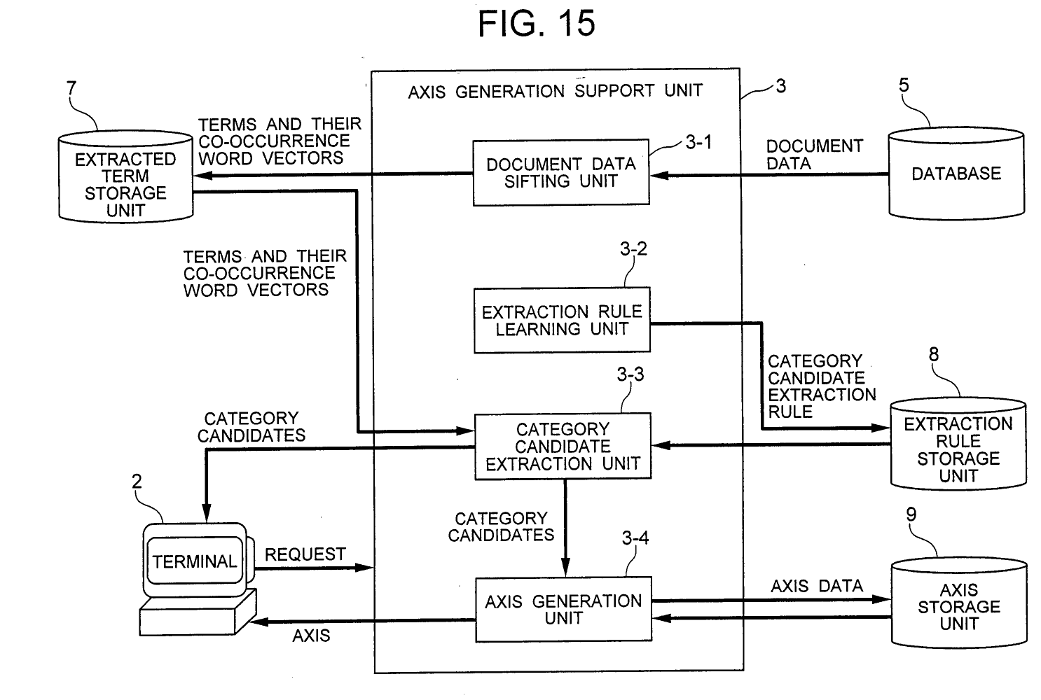

The axis generation support unit 3 comprises a document data sifting unit 3-1, an extraction rule learning unit 3-2, a category candidate extraction unit 3-3 and an axis generation unit 3-4. FIG. 15 shows details of the axis generation support unit 3 including a flow of data.

2.2.1 Function

The document data sifting unit 3-1 narrows the document data set in the database 5 down to a subset by a condition formula using the term specified by the user. If, for example, the user specifies “77E7S” as the condition formula, the document data set is narrowed down to a subset made up of only document data containing “77E7S”. In the document data subset that was sifted by “77E7S”, the document data sifting unit 3-1 generates co-occurrence word vectors for the terms in a descending order of appearance frequency and stores them in the extracted term storage unit 7 in the format shown in FIG. 26. At this time, the co-occurrence words for the sifted document data subset are stored in a memory area separate from the one in which the co-occurrence word extraction unit 4-3 stores the co-occurrence words. By the sifting of the document data set, it is possible to discover in the sifted subset those terms whose frequencies are low in the overall document data set. For example, in FIG. 4, when the user selects the product name “77E7S” displayed in the term list display field 3005, the document data sifting unit 3-1 narrows the document data set down to a subset consisting of document data containing “77E7S”.

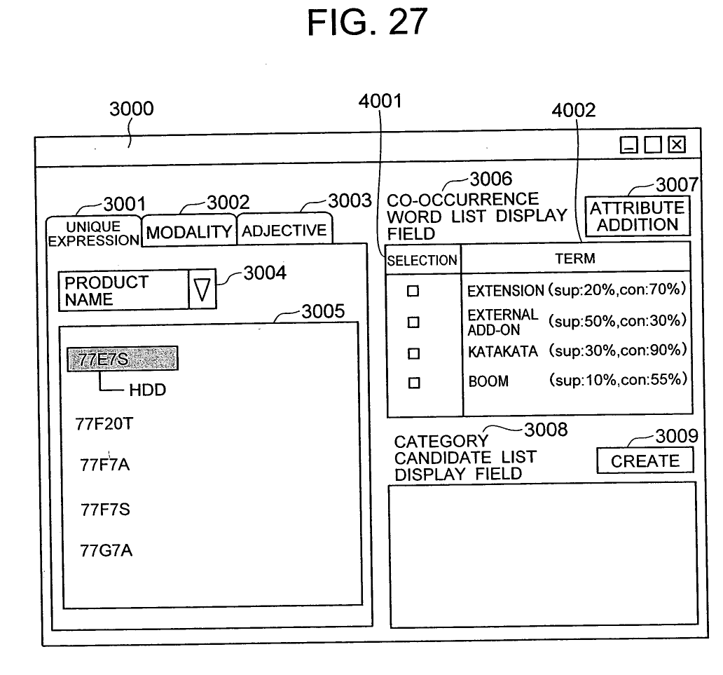

In this example, the co-occurrence word list display field 3006 shows “HDD”, “liquid crystal”, “TV” and “adapter” as the terms co-occurring with “77E7S”. An example case in which the document data subset, which was sifted by “77E7S”, is further narrowed down by “HDD” is shown in FIG. 27. The term list display field 3005 of FIG. 27 shows “77E7S” and “HDD” in a hierarchical structure so that the user can easily identify the level of sifting of the document data set. By this sifting, the user can find such terms as “extension”, “external add-on”, “boom” (booming or humming sound) and “katakata” (rattling sound) as co-occurrence words of “HDD”. Generally, these terms which can be found in the sifted document subset are normally difficult to find in the overall document data set because of their low frequencies but become easier to find by the sifting. Typical terms that can be made easy to find by this method are those whose appearance frequencies are low in the overall document set but which are highly likely to co-occur with certain terms when they appear.

The extraction rule learning unit 3-2 allows the user to add the same attribute to those terms which are likely to become category candidates, and determines co-occurrence word vectors for the attribute-added terms. For example, if an attribute “part name” is added to “HDD”, “liquid crystal” and “adapter”, the extraction rule learning unit 3-2 transforms the co-occurrence word vectors stored in the extracted term storage unit 7 into new co-occurrence word vectors whose format conforms to that of the co-occurrence word vectors shown in FIG. 8(a). Further, the unit stores the combination of the attribute-added terms and their co-occurrence word vectors in the extraction rule storage unit 8 as the category candidate extraction rules. In the extraction rule storage unit 8, the terms of the category candidate extraction rules are stored in the attribute-added term storage field 8001 and the co-occurrence word vectors of the rules are stored in the co-occurrence word vector storage field 8002.

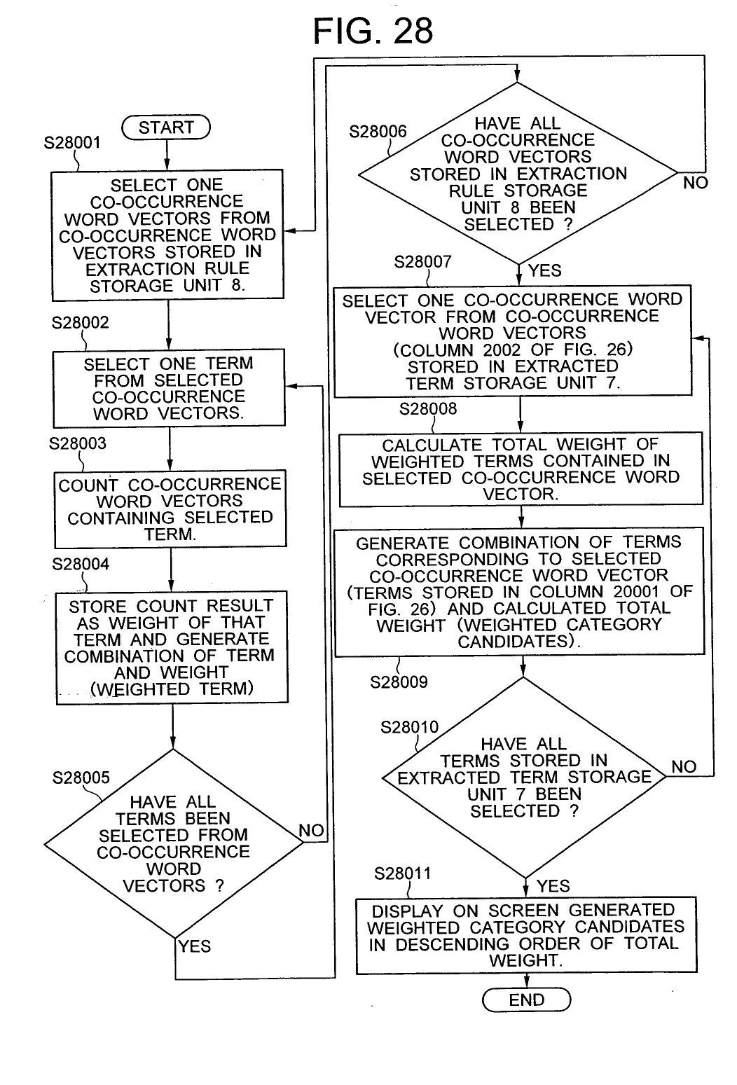

The category candidate extraction unit 3-3 extracts as category candidates those terms having co-occurrence word vectors similar to those of the attribute-added terms stored in the extraction rule storage unit 8. For example, as shown in FIG. 8(a), “keyboard”, “mouse” and “navi-station”, which have in their co-occurrence word vectors the same terms as the co-occurrence words such as “recognition” and “connection” included in the co-occurrence word vectors of the terms “HDD”, “liquid crystal” and “adapter” having an attribute “part name”, are extracted as category candidates. A category candidate extraction procedure in the category candidate extraction unit 3-3 is shown in FIG. 28. The procedure of FIG. 28 will be explained for an example case of FIG. 10. Before category candidates are displayed in the category candidate list display field 3008 of FIG. 10, the category candidate extraction unit 3-3 performs the following steps.
S28001-S28006: It is assumed that the terms and the co-occurrence word vectors shown in FIG. 8(a) are stored as category candidate extraction rules in the extraction rule storage unit 8. First, the co-occurrence word vectors containing the term “mount”, which is included in the co-occurrence word vector of “HDD”, are counted and a count result is added to the term as a weight. This term is called a weighted term. In the example of FIG. 8, since “mount” is included in only one co-occurrence word vector, the weighted term will be (mount, 1). Other weighted terms in the co-occurrence word vector of the term “HDD” are (strange, 1), (katakata, 1), (incorporate, 1), (recognition, 2), (connection, 2) and (record, 1). This process is performed on all co-occurrence word vectors in the extraction rule storage unit 8.
S28007-S28010: One of the co-occurrence word vectors stored in the extracted term storage unit 7 is selected. Suppose, for example, a co-occurrence word vector of a term “fan” is selected from among a plurality of co-occurrence word vectors shown in FIG. 26. At this time, the selected co-occurrence word vector is temporarily copied onto a memory of the category candidate extraction unit 3-3 in the format of the co-occurrence word vectors of FIG. 8(b). Terms contained in the selected co-occurrence word vector are compared with the previously generated, weighted terms. “Strange” has a weight 1 since its weighted term is (strange, 1); “incorporate” has a weight 1; and “connection” has a weight 2. These weights are summed up (total weight) and a combination of the total weight and the term “fan” is generated. This term is simply referred to as a category candidate and a combination of the total weight and the category candidate is called a weighted category candidate. In this example, the total weight is 4, so the weighted category candidate is (fan, 4). This processing is performed on all co-occurrence word vectors in the extracted term storage unit 7.
S28011: The generated, weighted category candidates are displayed on the screen in a descending order of total weight. For example, they are shown on the screen as in the category candidate list display field 3008 of FIG. 10.

According to the above procedure, when the user adds an attribute to terms, the category candidate extraction unit 3-3 dynamically displays category candidates on the screen. For example, when the user selects terms other than “HDD”, “liquid crystal” and “adapter” in the co-occurrence word list display field 3006 of FIG. 10 and adds an attribute to them, the category candidate list display field 3008 lists other category candidates.

The axis generation unit 3-4 generates one axis from those category candidates which the user has selected for axis generation from among the category candidates displayed in the axis generation screen 11000. For example, from a plurality of category candidates displayed on the axis generation screen 11000 of FIG. 11, the user clicks on check boxes in the category name selection field 11006 to select desired category candidates “HDD”, “fan”, “liquid crystal”, “adapter”, “mouse” and “LAN cable”. The axis generation unit 3-4 generates one axis using the user-specified axis name “PC part”.

2.2.2 Flow of Data

Data flows for the document data sifting unit 3-1, the extraction rule learning unit 3-2, the category candidate extraction unit 3-3 and the axis generation unit 3-4 shown in FIG. 15 will be explained. It is assumed that the axis generation support screen 3000 of FIG. 3 is displayed on the terminal 2.

The document data sifting unit 3-1 narrows the document data set down to a subset by one or more terms as a key that the user has selected from among the terms displayed on the term list display field 3005. That is, a set of document data containing the selected terms is generated. For example, in FIG. 3, if the user selects “77E7S” and “77F20T”, the unit generates a subset containing “77E7S” and “77F20T”. Using the subset, the unit generates co-occurrence word vectors for the terms in a descending order of frequency and stores the terms and their co-occurrence word vectors in the extracted term storage unit 7. The unit also uses the generated co-occurrence word vectors to display in the co-occurrence word list display field 3006 the co-occurrence words for the terms that the user has selected. In the example of FIG. 4, the user selects “77E7S” and its co-occurrence words “HDD”, “liquid crystal” “TV” and “adapter” are displayed.

The extraction rule learning unit 3-2 temporarily stores in a memory those terms that the user has selected from the terms displayed in the co-occurrence word list display field 3006. In the example of FIG. 5, the unit temporarily stores terms “HDD”, “liquid crystal” and “adapter” which the user has selected from the terms “HDD”, “liquid crystal, “TV” and “adapter” displayed in the co-occurrence word list display field 3006. Next, the extraction rule learning unit 3-2 adds the same attribute to the user-selected terms to generate co-occurrence word vectors for the attribute-added terms. In the example of FIG. 7, the unit adds the user-specified attribute “part name” to the terms “HDD”, “liquid crystal” and “adapter” to generate co-occurrence word vectors shown in FIG. 8(a). As a final step, the extraction rule learning unit 3-2 stores the attribute-added terms and their co-occurrence word vectors in the extraction rule storage unit 8 as the category candidate extraction rules.

The category candidate extraction unit 3-3 generates weighted terms from the co-occurrence word vectors of the category candidate extraction rules stored in the extraction rule storage unit 8, compares them with the co-occurrence word vectors in the extracted term storage unit 7 and extracts weighted category candidates. Further, the unit displays the category candidates on the terminal 2 in a descending order of weight and transfers the category candidates to the axis generation unit 3-4. For example, the category candidate extraction unit 3-3 displays category candidates on the screen of the terminal 2, as shown in the category candidate list display field 3008 of FIG. 10.

The axis generation unit 3-4 generates an axis from the category candidates received from the category candidate extraction unit 3-3 according to the request from the user and stores the generated axis in the axis storage unit 9. For example, when in the axis generation screen 11000 of FIG. 11, the user performs an operation to generate an axis “PC part” and clicks on the axis name decision button 11005, the axis generation unit 3-4 generates the axis “PC part” and stores it in the axis storage unit 9. At the same time, the axis generation unit 3-4 also displays the axis stored in the axis storage unit 9 on the screen of the terminal 2. For example, the axis is displayed as shown in FIG. 12.

2.3 Cross Tabulation Unit (Embodiment 1)

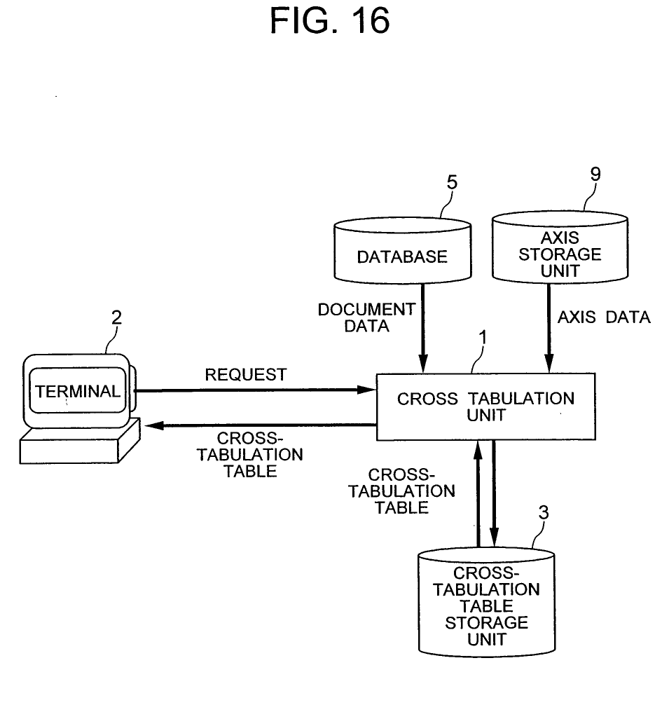

FIG. 16 shows details of the cross tabulation unit 1 including a data flow.

2.3.1 Function

The cross tabulation unit 1 of FIG. 16 cross-tabulates document data stored in the database 5 according to the ordinate and abscissa selected by the user. For example, in the cross-tabulation table generation screen 12000 of FIG. 12, when the user selects “PC part” for the ordinate and “abnormal sound” for the abscissa, the cross tabulation unit 1 generates an AND search formula for all combinations of the ordinate categories and the abscissa categories and executes the search. As a result of the cross tabulation, a cross-tabulation table shown in FIG. 13 is displayed on the screen of the terminal 2. One cell in the cross-tabulation table represents the number of document data collected as a result of search using the AND search formula. Thus, as a result of search based on the AND search formula using the ordinate category “HDD” and the abscissa category “boom” (booming or humming sound), 24 relevant documents are retrieved and a value of 24 is entered in the cell of “HDD” and “boom”.

2.3.2 Data Flow

The cross tabulation unit 1, according to the user instruction from the terminal 2, extracts the ordinate and abscissa from the axis storage unit 9. In the example of FIG. 12, the unit extracts from the axis storage unit 9 a search formula for categories making up the axes of “PC part” and “abnormal sound” selected by the user. Next, the unit cross-tabulates the document data in the database 5 by combining the category search formulas. As a last step, the unit stores the generated cross-tabulation tables in the cross-tabulation table storage unit 10. Upon request from the user, the unit extracts the cross-tabulation tables from the cross-tabulation table storage unit 10 for display on the terminal 2.

2.4 Cross Tabulation Unit (Embodiment 2)

FIG. 17 shows details of the cross tabulation unit 11 including data flows. The cross tabulation unit 11 comprises an axis synthesizing unit 11-1, a tabulation execution unit 11-2 and a cross-tabulation table ranking unit 11-3.

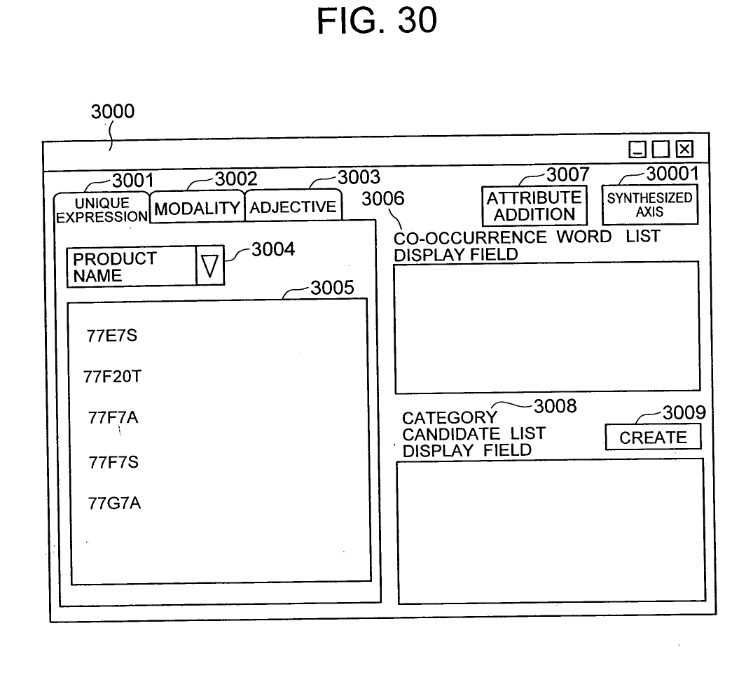

When the cross tabulation unit 11 is adopted, an axis synthesizing button 30001 is added to the axis generation support screen 3000, as shown in FIG. 30. The user can click on this button to display an axis synthesis execution screen 19000 of FIG. 19 on the terminal 2.

2.4.1 Function

The axis synthesizing unit 11-1 extracts two axes from a plurality of axes stored in the axis storage unit 9 and generate a synthesized axis. A search formula for the categories of the synthesized axis is an AND of the category search formulas of the two axes before being synthesized. FIG. 18 shows an example of a synthesized axis “XXX series-PC part”, which is formed by combining the axis “XXX series” and the axis “PC part”. A search formula for a lower-level category “HDD” of “77E7S” is “77E7S AND HDD”. As described earlier, for distinction between axes before being synthesized and a synthesized axis, the axes before being synthesized are called raw axes. These two raw axes are also called a raw axis pair.

By combining the paired raw axes it is possible to generate a more complex synthesized axis considering the content of document data. However, generating a synthesized axis at random can pose the following problems.
Almost no document data is available for the categories making up the synthesized axis. That is, most of document data is tabulated in category “others”. If cross-tabulation tables are generated using such a synthesized axis, no meaningful analysis can be made.
Document data concentrates in a particular category of the synthesized axis. That is, there is a strong deviation or bias in the number of document data collected among the categories of the synthesized axis. If cross-tabulation tables are generated using such a synthesized axis, a unique analysis to discover a hitherto unknown tendency by making comparison with other cells cannot be done.
A semantic or conceptual relation between the parent and child axes of the synthesized axis is not clear. Generating cross-tabulation tables using such a synthesized axis makes it difficult to obtain meaningful findings from the cross-tabulation tables.

To solve the above problems, the axis synthesizing unit 11-1 uses the following four references (scores).
1. “Document count in categories”: The number of document data collected in the categories of a synthesized axis.
2. “Document count deviation”: Mutual information volume representing the deviation in the number of document data collected in the categories of a synthesized axis.
3. “Level of co-occurrence”: Percentage of terms that are commonly contained in both the co-occurrence word vector of the parent axis categories and the co-occurrence word vector of the child axis categories.
4. “Frequency in the past”: The number of times that a pair of parent axis and child axis making up the synthesized axis was used in the past.

In the ranking reference selection field 19001 of the axis synthesis execution screen 19000 of FIG. 19, these scores correspond to “document count in categories”, “document count deviation”, “level of co-occurrence” and “frequency in the past” respectively. As the values of these scores increase, the quality of the synthesized axis improves. That is, as to the document count in categories, the higher the ratio of the number of documents classified in any of the categories to the number of other documents not classified in the categories, the higher the evaluation of the synthesized axis. As for the document count deviation, the more deviated among the categories the number of tabulated document data, the higher the evaluation of the synthesized axis. As for the level of co-occurrence, the higher the percentage of the terms contained in both the co-occurrence word vector of the parent axis categories and the co-occurrence word vector of the child axis categories, the higher the evaluation of the synthesized axis. As to the frequency in the past, the greater the number of times that the same combination of the parent and child axes was used in the past, the higher the evaluation of the synthesized axis.

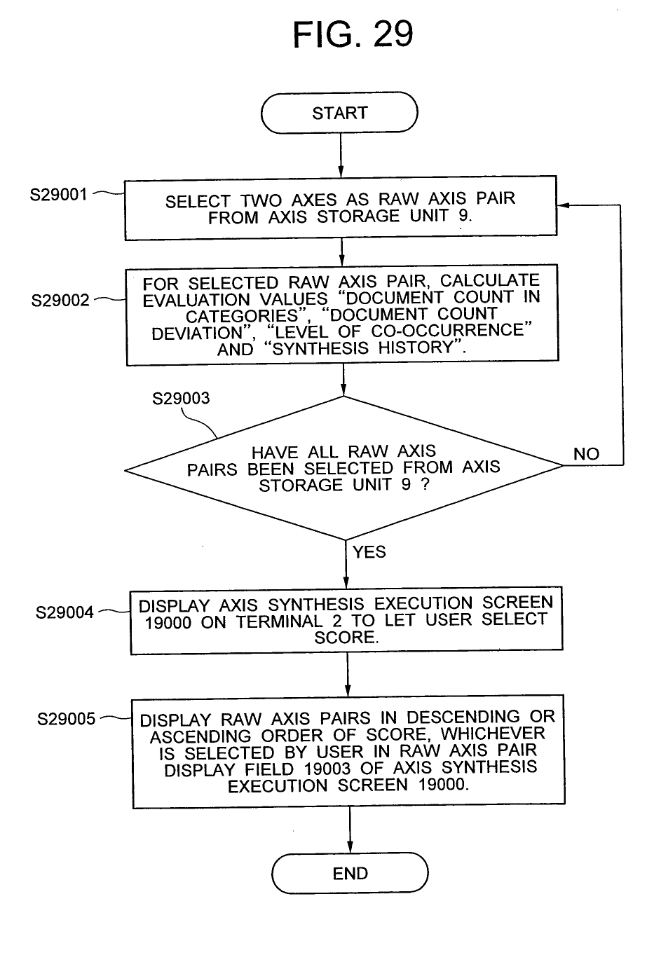

The axis synthesizing unit 11-1 performs the processing shown in FIG. 29 to generate a synthesized axis using the above scores. The processing of FIG. 29 will be explained by taking FIG. 19 as an example case. Before raw axis pairs are displayed in the raw axis pair display field 19003 of the axis synthesis execution screen 19000, the axis synthesizing unit 11-1 performs the following processing.
S29001-S29003: Before displaying the axis synthesis execution screen 19000 on the terminal 2, the axis synthesizing unit 11-1 generates all possible pairs of raw axes stored in the axis storage unit 9 and calculates the four scores for each of the raw axis pairs.
S29004-S29005: The axis synthesizing unit 11-1 displays the axis synthesis execution screen 19000 of FIG. 19 on the terminal 2. When the user in the ranking reference selection field 19001 selects “document count in categories”, the axis synthesizing unit 11-1 displays the raw axis pairs in the raw axis pair display field 19003 according to the calculated scores. In this example, raw axis pairs displayed include “XXX series”- “abnormal sound” and “XXX series”- “PC part”. In the score display field 19002 the maximum score value is taken as 100%.

The meaning of each score will be explained as follows.

If a synthesized axis is generated from the raw axis pair with a high score of “document count in categories”, it is possible to prevent many document data from being tabulated into category “others”. When simply combining the parent axis and the child axis, the axis synthesizing unit 11-1 calculates a total number of document data tabulated into the categories of synthesized axis, i.e., categories other than “others” category.

If a synthesized axis is generated from the raw axis pair with a high score of “document count deviation”, the document data can be prevented from becoming concentrated in a particular category of the synthesized axis. Further, in cross-tabulation tables using synthesized axes generated based on this score, a strong deviation in the document data count can be eliminated. Conversely, a cross-tabulation table with some deviation indicates that the document data has a certain feature, providing a possibility of discovering new knowledge. Therefore the user may be able to generate a cross-tabulation table with some deviation in the document data count by generating a synthesized axis from a raw axis pair with a relatively small value of this score. The axis synthesizing unit 11-1 calculates a mutual information volume for the raw axis pair that represents a deviation in the document data count in the synthesized axis. First, an entropy of a raw axis which will form the parent axis is calculated. Let the number of document data classified into each category of the parent axis A be taᵢ (1≦i≦n) (n is the number of categories) and the total number of document data be defined by equation 1. Then, the entropy when the document data is tabulated using the axis A is given by equation 2.

$$\begin{matrix}ta = {\sum }_{i = 1}^{n} {ta}_{i} & ( 1 ) \\ Info ( ta , A ) = - {\sum }_{i = 1}^{n} ( \frac{{ta}_{i}}{ta} {log}_{2} \frac{{ta}_{i}}{ta} ) & ( 2 )\end{matrix}$$

An average of entropy when the parent axis and the child axis are combined (referred to as a post-event entropy) is calculated. When the parent axis A and the child axis B are combined, the categories of a synthesized axis C have a hierarchical structure in which each of the parent axis categories (higher-level categories) is subdivided into the categories of the child axis. The number of document data gathered in each of the categories of the synthesized axis C is expressed as tcᵢⱼ (1≦i≦n, 1≦j≦m) The number of documents for each higher-level category in the synthesized axis C is given by equation 3 and a simple total of documents by equation 4. At this time, the post-event entropy of the synthesized axis C can be expressed by equation 5.

$$\begin{matrix}{tc}_{i} = {\sum }_{j = 1}^{m} {tc}_{ij} & ( 3 ) \\ tc = {\sum }_{i = 1}^{n} {tc}_{i} & ( 4 ) \\ {Info}_{div} ( tc , C ) = {\sum }_{i = 1}^{n} \frac{{tc}_{i}}{tc} ( - {\sum }_{j = 1}^{m} ( \frac{{tc}_{ij}}{{tc}_{i}} {log}_{2} \frac{{tc}_{ij}}{{tc}_{i}} ) ) & ( 5 )\end{matrix}$$

The mutual information volume can be given by equation 6.
I(C;A)=Info(ta,A)−Info_{div}(tc,C) (6)

If the value of the mutual information volume is small, the synthesized axis has a small deviation in the document data count. Conversely, a larger value results in a synthesized axis with a large deviation.

The “level of co-occurrence” represents a semantic closeness of paired raw axes. The larger the score, the closer they are semantically to each other. Before generating a synthesized axis, the axis synthesizing unit 11-1 extracts co-occurrence word vectors for all categories of the parent axis and co-occurrence word vectors for all categories of the child axis. That is, the same number of co-occurrence word vectors as the categories of the parent axis (referred to as parent axis co-occurrence word vectors) and the same number of co-occurrence word vectors as the categories of the child axis (child axis co-occurrence word vectors) are extracted. Next, the parent axis co-occurrence word vectors and the child axis co-occurrence word vectors are checked against each other to determine the number of common terms that are contained in both the parent and child axis co-occurrence word vectors. As a last step, the number of common terms is divided by the total number of terms contained in the parent axis co-occurrence word vectors to determine a percentage of those terms in the parent axis co-occurrence word vectors that are also contained in the child axis co-occurrence word vectors. For example, if a parent axis “complaint” and a child axis “abnormal sound” have a high co-occurrence level, it is highly likely that topics related to “abnormal sound” are included in topics related to “complaint”. Thus, from this raw axis pair, a synthesized axis can be generated which has the point of view of “complaint” subdivided by the point of view of “abnormal sound”.

When a synthesized axis is generated based on the “frequency in the past”, an axis based on a history of past axis synthesizing operations can be produced. The axis synthesizing unit 11-1 refers to the history of synthesized axes stored in the axis storage unit 9 and calculates the number of times that the raw axis pairs in the axis storage unit 9 were used for axis synthesizing. The greater the number of times of use, the more effective the raw axis pairs will be for the axis synthesizing.

Next, the tabulation execution unit 11-2 and the cross-tabulation table ranking unit 11-3 will be explained. The tabulation execution unit 11-2, like the cross tabulation unit 1, executes the cross tabulation on the document data.

The cross-tabulation table ranking unit 11-3 ranks the tables according to the above-mentioned four scores used by the axis synthesizing unit 11-1. The scores for the cross-tabulation table are as follows.
1. “Document count in categories”: The number of document data collected in the cells of the cross-tabulation table (in other than a cell “others”).
2. “Document count deviation”: Mutual information volume of the ordinate and the abscissa in the cross-tabulation table.
3. “Level of co-occurrence”: Percentage of terms that are commonly contained in both the co-occurrence word vector of the ordinate categories and the co-occurrence word vector of the abscissa categories.
4. “Frequency in the past”: The number of times that a combination of ordinate and abscissa forming the cross-tabulation table was used in the past.

The greater the values of these scores “document count in categories”, “document count deviation” and “frequency in the past”, the higher the quality of the cross-tabulation table. The scores are determined by taking the largest value as 100. As to the score “level of co-occurrence”, it is noted that the quality improves as the score value decreases. So, the score in the cross-tabulation table is determined by taking the lowest possible value as 100.

If a cross-tabulation table is generated using an ordinate and an abscissa with a high value of score “document count in categories”, it is possible to prevent a generation of a coarse cross-tabulation table in which almost all cells are 0. This score is determined by calculating a total of the number of document data collected in other than the category “others”.

If a cross-tabulation table is generated using an ordinate and an abscissa with a high value of core “document count deviation”, a cross-tabulation able with little deviation in the document data count an be generated. Conversely, by using an ordinate and an abscissa with an intermediate level of the score, a cross-tabulation table with some deviation can be generated. A cross-tabulation table with some degree of deviation in the number of tabulated document data indicates a certain feature (tendency) of the document data. Thus, by investigating those document data classified into the cell with some deviation in the cross-tabulation table, new knowledge may be discovered. For all cross-tabulation tables stored in the cross-tabulation table storage unit 10, the cross-tabulation table ranking unit 11-3 calculates the mutual information volume when the ordinate and the abscissa are cross-tabulated, as in the calculation of the mutual information volume for a synthesized axis.

If a cross-tabulation table is generated using an ordinate and an abscissa with a low value of score “level of co-occurrence”, a cross-tabulation table whose ordinate and abscissa do not depend on each other can be generated. The method of calculating this score is similar to that of the score for a synthesized axis. The dependence between the ordinate and the abscissa is produced by the categories making up the ordinate (search formula value) and the categories making up the abscissa (search formula value) appearing simultaneously in the document data. Such a dependence relation will constitute a factor responsible for generating a coarse cross-tabulation table. By selecting independent ordinate and abscissa based on this score, the user can prevent a generation of a coarse cross-tabulation table, as in the case of the score “document count deviation”.

If a cross-tabulation table is generated based on the score “frequency in the past”, it is possible to generate a cross-tabulation table that was used frequently in the past. The axis synthesizing unit 11-1 refers to the history of the cross-tabulation tables stored in the cross-tabulation table storage unit 10 and retrieves the ordinates and abscissas that were used in the past and calculates the number of times that they were used.

The above four scores used in the axis synthesizing and in the combining of the ordinate and abscissa may be used independently or in combination.

2.4.1 Data Flow

The axis synthesizing unit 11-1 first calculates the above four scores for all possible pairs of raw axes in the axis storage unit 9. Next, the unit displays axis synthesis execution screen 19000 of FIG. 19 on the terminal 2 to allow the user to select the score in the ranking reference selection field 19001.

At the last step, based on the score selected by the user, the axis synthesizing unit 11-1 displays the raw axis pairs in the raw axis pair display field 19003 in a descending order of score. The user can reverse the order in which the raw axis pairs are shown arrayed in the raw axis pair display field 19003 by clicking on “score” in the score display field 19002.

The tabulation execution unit 11-2 generates cross-tabulation tables for all combinations of parent axes and child axes stored in the axis storage unit 9 and stores the generated tables in the cross-tabulation table storage unit 10.

The cross-tabulation table ranking unit 11-3 first displays the cross-tabulation table selection display screen 20000 of FIG. 20 on the terminal 2. Next, the unit allows the user to select a reference (i.e., kind of score) in the ranking reference selection field 19001. As a last step, based on the score chosen by the user, the unit 11-3 displays pairs of ordinate and abscissa of the cross-tabulation tables in the two-axis display field 20002 in a descending order of score. As in the axis synthesis execution screen 19000, the user can click on “score” in the score display field 20001 to reverse the order in which the ordinate-abscissa pairs of the cross-tabulation tables are shown arrayed in the two-axis display field 20002. The ordinate-abscissa pairs may, for example, be displayed as follows. In the cross-tabulation table selection display screen 20000 of FIG. 20, if the user selects “document count in categories”, the largest score is taken as 100% and the axis names representing the cross-tabulation tables are arranged on the display according to the score value.

This invention can be applied to a text mining system and an information retrieval system with the document data cross tabulation function.

It should be further understood by those skilled in the art that although the foregoing description has been made on embodiments of the invention, the invention is not limited thereto and various changes and modifications may be made without departing from the spirit of the invention and the scope of the appended claims.

1. In a text mining system having a database to store a plurality of documents, a processing unit, a display unit and a user input device; a document tabulation support method for generating a document tabulation axis containing a plurality of categories for document tabulation, wherein the document tabulation classifies the plurality of documents into the plurality of categories to create a table, the document tabulation support method comprising the steps of:
displaying on the display unit a plurality of terms extracted from the plurality of documents stored in the database;
accepting in the user input device a first user input to select at least a part of the displayed, extracted terms;
extracting co-occurrence words of the selected, extracted terms from the plurality of documents, setting the co-occurrence words as a plurality of category candidates and evaluating a co-occurrence strength between the plurality of category candidates and the extracted terms;
displaying on the display unit at least a part of the category candidates in the order of the co-occurrence strength;
accepting in the user input device a second user input to select at least a part of the displayed category candidates; and
in the processing unit, determining the category candidates selected based on the first user input as categories and generating a document tabulation axis by using the categories.

2. A document tabulation support method according to claim 1, further including the steps of:
evaluating the plurality of category candidates based on information about co-occurrence words of the selected category candidates;
displaying on the display unit the plurality of category candidates according to a result of the evaluation; and
in the processing unit, adding to the categories category candidates selected by a third user input accepted in the user input device and generating a document tabulation axis by using the categories.

3. A document tabulation support method according to claim 1, wherein the processing unit narrows document data down to those document data containing the extracted terms selected by the first user input, evaluates a co-occurrence strength between the plurality of category candidates and the extracted terms in the narrowed document data, and displays on the display unit the first plurality of category candidates in the order of the co-occurrence strength.

4. A document tabulation support method according to claim 1, wherein the processing unit generates a plurality of document tabulation axes, extracts a plurality of axis pairs, or combinations of two axes, from the plurality of document tabulation axes, and calculates evaluation values to evaluate a quality of document tabulation that uses a synthesized axis comprised of two document tabulation axes or each of the plurality of axis pairs;
wherein the display unit displays the plurality of axis pairs in the order of magnitude of the evaluation value.

5. A document tabulation support method according to claim 1, wherein the processing unit creates a plurality of document tabulation axes, extracts a plurality of cross-tabulation table candidate axis pairs, or combinations of two axes, from the plurality of document tabulation axes, and calculates evaluation values to evaluate a quality of document tabulation that uses as an ordinate and an abscissa the two document tabulation axes in each of the plurality of cross-tabulation table candidate axis pairs;
wherein the display unit displays the plurality of cross-tabulation table candidate axis pairs in the order of magnitude of the evaluation value.

6. A document tabulation support method according to claim 5, wherein at least one of the document tabulation axes from which to extract the cross-tabulation table candidate axis pairs is a synthesized axis formed by combining two document tabulation axes.

7. A text mining system for aiding a generation of a document tabulation axis containing a plurality of categories for document tabulation, wherein the document tabulation classifies a plurality of documents into the plurality of categories to create a table, the text mining system comprising:
a database to store a plurality of documents;
a processing unit to select a plurality of categories for the document tabulation axis by using the plurality of documents read from the database;
a display unit; and
a user input device to accept a user input;
wherein, for extracted terms selected by a first input from the user input device, the processing unit extracts co-occurrence words from the plurality of documents to determine a plurality of category candidates, evaluates a co-occurrence strength between the plurality of the category candidates and the extracted terms, determines as categories at least a part of the category candidates that is selected by a second input from the user input device, and generates a document tabulation axis by using the categories;
wherein the display unit displays the extracted terms and also displays the plurality of category candidates in the order of the evaluated co-occurrence strength.

8. A text mining system according to claim 7, wherein the processing unit evaluates the plurality of category candidates based on information about co-occurrence words of the determined categories,
the display unit displays the plurality of category candidates in the order based on their evaluation, and
the processing unit adds to the categories category candidates selected by a third input accepted in the user input device and creates a document tabulation axis by using the categories.

9. A text mining system according to claim 7, wherein the processing unit narrows document data down to those document data containing the extracted terms selected by the first user input and evaluates a co-occurrence strength between the plurality of category candidates and the extracted terms in the narrowed document data, and the display unit displays the first plurality of category candidates in the order of the co-occurrence strength.

10. A text mining system according to claim 7, wherein the processing unit creates a plurality of document tabulation axes, extracts a plurality of axis pairs, or combinations of two axes, from the plurality of document tabulation axes, and calculates evaluation values to evaluate a quality of document tabulation that uses a synthesized axis comprised of two document tabulation axes or each of the plurality of axis pairs;
wherein the display unit displays the plurality of axis pairs in the order of magnitude of the evaluation value.

11. A text mining system according to claim 7, wherein the processing unit creates a plurality of document tabulation axes, extracts a plurality of cross-tabulation table candidate axis pairs, or combinations of two axes, from the plurality of document tabulation axes, and calculates evaluation values to evaluate a quality of document tabulation that uses as an ordinate and an abscissa the two document tabulation axes in each of the plurality of cross-tabulation table candidate axis pairs;
wherein the display unit displays the plurality of cross-tabulation table candidate axis pairs in the order of magnitude of the evaluation value.

12. A text mining system according to claim 11, wherein at least one of the document tabulation axes from which to extract the cross-tabulation table candidate axis pairs is a synthesized axis formed by combining two document tabulation axes.

13. In a text mining system having a database to store a plurality of documents, a processing unit, a display unit and a user input device; a document tabulation support program for generating a document tabulation axis containing a plurality of categories for document tabulation, wherein the document tabulation classifies the plurality of documents into the plurality of categories to create a table, the document tabulation support program comprising:
a first step of displaying on the display unit a plurality of terms extracted from the plurality of documents stored in the database;
a second step of accepting in the user input device a first user input to select at least a part of the displayed, extracted terms;
a third step of causing the processing unit to extract co-occurrence words of the selected, extracted terms from the plurality of documents, to set the co-occurrence words as a plurality of category candidates and to evaluate a co-occurrence strength between the plurality of category candidates and the extracted terms;
a fourth step of displaying on the display unit at least a part of the category candidates in the order of the co-occurrence strength;
a fifth step of accepting in the user input device a second user input to select at least a part of the displayed category candidates;
a sixth step of causing the processing unit to determine the category candidates selected based on the first user input as categories; and
a seventh step of causing the processing unit to create a document tabulation axis by using the categories.

14. A document tabulation support program according to claim 13, wherein the sixth step includes an eighth step of evaluating the plurality of category candidates based on information of co-occurrence words of the determined categories and a ninth step of adding to the categories category candidates selected by a third user input accepted in the user input device.

15. A document tabulation support program according to claim 13, wherein the third step includes a tenth step of narrowing document data down to those document data containing the extracted terms selected by the first user input, and evaluates a co-occurrence strength between the plurality of category candidates and the extracted terms in the narrowed document data.

16. A document tabulation support program according to claim 13, wherein the text mining system creates a plurality of document tabulation axes by performing the first to seventh step;
wherein the document tabulation support program causes the processing unit to execute an 11th step of extracting a plurality of axis pairs, or combinations of two axes, from the plurality of document tabulation axes and calculating evaluation values to evaluate a quality of document tabulation that uses a synthesized axis comprised of two document tabulation axes or each of the plurality of axis pairs;
wherein the document tabulation support program also causes the display unit to execute a 12th step of displaying the plurality of axis pairs in the order of magnitude of the evaluation value.

17. A document tabulation support program according to claim 13, wherein the text mining system creates a plurality of document tabulation axes by performing the first to seventh step;
wherein the document tabulation support program causes the processing unit to execute an 13th step of extracting a plurality of cross-tabulation table candidate axis pairs, or combinations of two axes, from the plurality of document tabulation axes and calculating evaluation values to evaluate a quality of document tabulation that uses as an ordinate the two document tabulation axes in each of the plurality of cross-tabulation table candidate axis pairs;
wherein the document tabulation support program also causes the display unit to execute a 14th step of displaying the plurality of cross-tabulation table candidate axis pairs in the order of magnitude of the evaluation value.

18. A document tabulation support program according to claim 17, wherein at least one of the document tabulation axes from which to extract the cross-tabulation table candidate axis pairs is a synthesized axis formed by combining two document tabulation axes.
